(19) United States
(12) Patent Application Publication
(10) Pub. No.: US 2023/0078537 A1
(43) Pub. Date: Mar. 16, 2023

(54) CHANNEL STATE INFORMATION REPORTING FOR RECONFIGURABLE INTELLIGENT SURFACES

(71) Applicant: QUALCOMM Incorporated, San Diego, CA (US)

(72) Inventors: Srinivas Yerramalli, Hyderabad (IN); Wooseok Nam, San Diego, CA (US); Tao Luo, San Diego, CA (US); Junyi Li, Fairless Hills, PA (US); Juan Montojo, San Diego, CA (US)

(21) Appl. No.: 17/477,234

(22) Filed: Sep. 16, 2021

(51) Int. Cl. H04L 5/00; H04B 7/06; H04W 72/04; H04W 72/06

(52) U.S. Cl. CPC H04L 5/0048; H04B 7/0626; H04B 7/0639; H04W 72/046; H04W 72/06

(57) ABSTRACT

Methods, systems, and devices for wireless communication are described. In some wireless communications systems, wireless devices may communicate using reconfigurable intelligent surfaces (RIS) for improved spatial diversity. A base station may transmit, to a user equipment (UE), control signaling indicating a configuration for a channel state information (CSI) reference signal (RS) resource set corresponding to one or more RISs and a communication beam threshold for the one or more RISs. The CSI-RS resource set may be specific to one RIS or may configure resources for multiple RISs. The UE may receive, according to the CSI-RS resource set, a set of CSI-RSs corresponding to a set of respective communication beams (e.g., reflected beams from the one or more RISs). The UE may transmit a CSI report indicating one or more communication beams selected by the UE based on the set of CSI-RSs and the communication beam threshold.

### FIELD OF TECHNOLOGY

The following relates to wireless communications, including channel state information (CSI) reporting for reconfigurable intelligent surfaces (RISs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support beamforming techniques for communications between wireless devices. In some examples, wireless communications systems may include RISs to facilitate transmissions between wireless devices. A RIS may include a quantity of reflective, electrically-controllable elements. The RIS may reflect transmissions in a specific direction based on a current configuration of the MS elements. For example, a RIS may receive a beamformed communication at an angle of incidence and may reflect the beamformed communication at an angle different from the angle of incidence. In some cases, beamformed communications reflected by a MS may be referred to as MS-aided communications or RIS-aided transmissions. In some examples, however, a UE receiving beamformed communications from a base station via a RIS may fail to determine that multiple beams are reflected from the same RIS. In some such examples, beam management between the UE and base station may introduce interference based on the RIS, the UE may request beam-based diversity that is not supported by the RIS, or both.

### SUMMARY

The described techniques relate to improved methods, systems, devices, and apparatuses that support CSI reporting for RISs. Generally, the described techniques provide for CSI reporting and beam management in wireless communications systems including one or more RISs. A base station may transmit control signaling indicating a configuration for a CSI reference signal (RS) resource set corresponding to one or more RISs and a communication beam threshold for the one or more RISs. For example, the communication beam threshold may be based on a capability of the one or more RISs to concurrently reflect different beamformed signals. In some examples, the base station may configure a CSI-RS resource set specific to one RIS. In some other examples, the base station may configure a CSI-RS resource set for a set of multiple RISs. The control signaling may indicate which CSI-RS resources may be concurrently used by a UE, corresponding to which beamformed signals may be reflected concurrently by the one or more RISs. The UE may receive the control signaling and may receive, according to the configured CSI-RS resource set, a set of CSI-RSs corresponding to a set of communication beams. The UE may select one or more communication beams of the set for communicating with the base station based on the received CSI-RSs (e.g., according to the communication beam threshold) and may transmit a CSI report indicating the selected one or more communication beams to the base station. By using a CSI-RS resource set corresponding to one or more RISs and a corresponding communication beam threshold, the base station may configure the UE to select beams for communication that support concurrent communications and avoid selecting beams for communication that are reflections of the same beam from the base station (and, correspondingly, do not support concurrent communications).

A method for wireless communications at a UE is described. The method may include receiving control signaling indicating a configuration for a channel state information reference signal resource set corresponding to one or more reconfigurable intelligent surfaces and a communication beam threshold for the one or more reconfigurable intelligent surfaces, receiving, according to the channel state information reference signal resource set and via the one or more reconfigurable intelligent surfaces, a set of multiple channel state information reference signals corresponding to a set of multiple respective communication beams, and transmitting a channel state information report indicating one or more communication beams of the set of multiple respective communication beams based on the set of multiple channel state information reference signals and on the communication beam threshold.

An apparatus for wireless communications at a UE is described. The apparatus may include a processor, memory coupled with the processor, and instructions stored in the memory. The instructions may be executable by the processor to cause the apparatus to receive control signaling indicating a configuration for a channel state information reference signal resource set corresponding to one or more reconfigurable intelligent surfaces and a communication beam threshold for the one or more reconfigurable intelligent surfaces, receive, according to the channel state information reference signal resource set and via the one or more reconfigurable intelligent surfaces, a set of multiple channel state information reference signals corresponding to a set of multiple respective communication beams, and transmit a channel state information report indicating one or more communication beams of the set of multiple respective communication beams based on the set of multiple channel state information reference signals and on the communication beam threshold.

Another apparatus for wireless communications at a UE is described. The apparatus may include means for receiving control signaling indicating a configuration for a channel state information reference signal resource set corresponding to one or more reconfigurable intelligent surfaces and a communication beam threshold for the one or more reconfigurable intelligent surfaces, means for receiving, according to the channel state information reference signal resource set and via the one or more reconfigurable intelligent surfaces, a set of multiple channel state information reference signals corresponding to a set of multiple respective communication beams, and means for transmitting a channel state information report indicating one or more communication beams of the set of multiple respective communication beams based on the set of multiple channel state information reference signals and on the communication beam threshold.

A non-transitory computer-readable medium storing code for wireless communications at a UE is described. The code may include instructions executable by a processor to receive control signaling indicating a configuration for a channel state information reference signal resource set corresponding to one or more reconfigurable intelligent surfaces and a communication beam threshold for the one or more reconfigurable intelligent surfaces, receive, according to the channel state information reference signal resource set and via the one or more reconfigurable intelligent surfaces, a set of multiple channel state information reference signals corresponding to a set of multiple respective communication beams, and transmit a channel state information report indicating one or more communication beams of the set of multiple respective communication beams based on the set of multiple channel state information reference signals and on the communication beam threshold.

In some examples of the method, apparatuses, and non-transitory computer-readable medium described herein, the control signaling includes a rank threshold indicator for the channel state information reference signal resource set and the method, apparatuses, and non-transitory computer-readable medium may include further operations, features, means, or instructions for determining a rank threshold for the one or more reconfigurable intelligent surfaces based on the rank threshold indicator, the communication beam threshold corresponding to the rank threshold.

In some examples of the method, apparatuses, and non-transitory computer-readable medium described herein, the control signaling includes an indication of which resources of the channel state information reference signal resource set may be concurrently scheduled and the method, apparatuses, and non-transitory computer-readable medium may include further operations, features, means, or instructions for selecting the one or more communication beams based on the indication of which resources of the channel state information reference signal resource set may be concurrently scheduled, where the channel state information report may be based on the selecting.

In some examples of the method, apparatuses, and non-transitory computer-readable medium described herein, the control signaling includes an indication of which resources of the channel state information reference signal resource set may not be concurrently scheduled and the method, apparatuses, and non-transitory computer-readable medium may include further operations, features, means, or instructions for selecting the one or more communication beams based on the indication of which resources of the channel state information reference signal resource set may not be concurrently scheduled, where the channel state information report may be based on the selecting.

Some examples of the method, apparatuses, and non-transitory computer-readable medium described herein may further include operations, features, means, or instructions for determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces and selecting a first one or more communication beams based on the first group of resources and a first communication beam threshold and selecting a second one or more communication beams based on the second group of resources and a second communication beam threshold, where the channel state information report may be based on the selecting the first one or more communication beams and selecting the second one or more communication beams.

In some examples of the method, apparatuses, and non-transitory computer-readable medium described herein, the control signaling further indicates the first group of resources and the second group of resources, the determining based on the control signaling.

Some examples of the method, apparatuses, and non-transitory computer-readable medium described herein may further include operations, features, means, or instructions for detecting, in a first set of channel state information reference signals of the set of multiple channel state information reference signals received in the first group of resources, a first signature associated with the first reconfigurable intelligent surface and detecting, in a second set of channel state information reference signals of the set of multiple channel state information reference signals received in the second group of resources, a second signature associated with the second reconfigurable intelligent surface, where the determining may be based on detecting the first signature and detecting the second signature.

In some examples of the method, apparatuses, and non-transitory computer-readable medium described herein, the control signaling further indicates a first rank threshold corresponding to the first signature and a second rank threshold corresponding to the second signature, the first communication beam threshold corresponding to the first rank threshold and the second communication beam threshold corresponding to the second rank threshold.

In some examples of the method, apparatuses, and non-transitory computer-readable medium described herein, the channel state information reference signal resource set corresponds to a first reconfigurable intelligent surface, and the control signaling further configures a second channel state information reference signal resource set corresponding to a second reconfigurable intelligent surface.

In some examples of the method, apparatuses, and non-transitory computer-readable medium described herein, the communication beam threshold may be for both the first reconfigurable intelligent surface and the second reconfigurable intelligent surface.

In some examples of the method, apparatuses, and non-transitory computer-readable medium described herein, the communication beam threshold may be for the first reconfigurable intelligent surface and the control signaling further configures a second communication beam threshold for the second reconfigurable intelligent surface.

In some examples of the method, apparatuses, and non-transitory computer-readable medium described herein, the communication beam threshold may be based on a concurrent beam transmission capability of the first reconfigurable intelligent surface.

Some examples of the method, apparatuses, and non-transitory computer-readable medium described herein may further include operations, features, means, or instructions for selecting a precoder based on the one or more communication beams and a quantity of reconfigurable intelligent surfaces corresponding to the one or more communication beams, where the channel state information report further indicates the selected precoder.

In some examples of the method, apparatuses, and non-transitory computer-readable medium described herein, the precoder supports coherent precoding based on the one or more communication beams corresponding to one reconfigurable intelligent surface.

In some examples of the method, apparatuses, and non-transitory computer-readable medium described herein, the precoder supports non-coherent precoding based on the one or more communication beams corresponding to a set of multiple reconfigurable intelligent surfaces.

Some examples of the method, apparatuses, and non-transitory computer-readable medium described herein may further include operations, features, means, or instructions for communicating data with a base station via at least one reconfigurable intelligent surface of the one or more reconfigurable intelligent surfaces using the one or more communication beams based on the channel state information report.

In some examples of the method, apparatuses, and non-transitory computer-readable medium described herein, the channel state information report may be transmitted via at least one reconfigurable intelligent surface of the one or more reconfigurable intelligent surfaces.

A method for wireless communications at a base station is described. The method may include transmitting, to a UE, control signaling indicating a configuration for a channel state information reference signal resource set corresponding to one or more reconfigurable intelligent surfaces and a communication beam threshold for the one or more reconfigurable intelligent surfaces, transmitting, to the UE via the one or more reconfigurable intelligent surfaces and according to the channel state information reference signal resource set, a set of multiple channel state information reference signals corresponding to a set of multiple respective communication beams, and receiving, from the UE, a channel state information report indicating one or more communication beams of the set of multiple respective communication beams based on the set of multiple channel state information reference signals and on the communication beam threshold.

An apparatus for wireless communications at a base station is described. The apparatus may include a processor, memory coupled with the processor, and instructions stored in the memory. The instructions may be executable by the processor to cause the apparatus to transmit, to a UE, control signaling indicating a configuration for a channel state information reference signal resource set corresponding to one or more reconfigurable intelligent surfaces and a communication beam threshold for the one or more reconfigurable intelligent surfaces, transmit, to the UE via the one or more reconfigurable intelligent surfaces and according to the channel state information reference signal resource set, a set of multiple channel state information reference signals corresponding to a set of multiple respective communication beams, and receive, from the UE, a channel state information report indicating one or more communication beams of the set of multiple respective communication beams based on the set of multiple channel state information reference signals and on the communication beam threshold.

Another apparatus for wireless communications at a base station is described. The apparatus may include means for transmitting, to a UE, control signaling indicating a configuration for a channel state information reference signal resource set corresponding to one or more reconfigurable intelligent surfaces and a communication beam threshold for the one or more reconfigurable intelligent surfaces, means for transmitting, to the UE via the one or more reconfigurable intelligent surfaces and according to the channel state information reference signal resource set, a set of multiple channel state information reference signals corresponding to a set of multiple respective communication beams, and means for receiving, from the UE, a channel state information report indicating one or more communication beams of the set of multiple respective communication beams based on the set of multiple channel state information reference signals and on the communication beam threshold.

A non-transitory computer-readable medium storing code for wireless communications at a base station is described. The code may include instructions executable by a processor to transmit, to a UE, control signaling indicating a configuration for a channel state information reference signal resource set corresponding to one or more reconfigurable intelligent surfaces and a communication beam threshold for the one or more reconfigurable intelligent surfaces, transmit, to the UE via the one or more reconfigurable intelligent surfaces and according to the channel state information reference signal resource set, a set of multiple channel state information reference signals corresponding to a set of multiple respective communication beams, and receive, from the UE, a channel state information report indicating one or more communication beams of the set of multiple respective communication beams based on the set of multiple channel state information reference signals and on the communication beam threshold.

Some examples of the method, apparatuses, and non-transitory computer-readable medium described herein may further include operations, features, means, or instructions for determining a rank threshold for the channel state information reference signal resource set based on an association between the set of multiple channel state information reference signals and the one or more reconfigurable intelligent surfaces, where the control signaling includes a rank threshold indicator indicating the rank threshold, and where the indicated one or more communication beams may be based on the rank threshold.

Some examples of the method, apparatuses, and non-transitory computer-readable medium described herein may further include operations, features, means, or instructions for determining which resources of the channel state information reference signal resource set may be concurrently scheduled based on an association between the set of multiple channel state information reference signals and the one or more reconfigurable intelligent surfaces, where the control signaling includes an indication of which resources of the channel state information reference signal resource set may be concurrently scheduled, and where the indicated one or more communication beams may be based on the indication.

Some examples of the method, apparatuses, and non-transitory computer-readable medium described herein may further include operations, features, means, or instructions for determining which resources of the channel state information reference signal resource set may not be concurrently scheduled based on an association between the set of multiple channel state information reference signals and the one or more reconfigurable intelligent surfaces, where the control signaling includes an indication of which resources of the channel state information reference signal resource set may not be concurrently scheduled, and where the indicated one or more communication beams may be based on the indication.

Some examples of the method, apparatuses, and non-transitory computer-readable medium described herein may further include operations, features, means, or instructions for determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces, where the control signaling further indicates the first group of resources and the second group of resources, and where the indicated one or more communication beams may be based on the first group of resources and the second group of resources.

Some examples of the method, apparatuses, and non-transitory computer-readable medium described herein may further include operations, features, means, or instructions for determining a first group of resources of the channel state information reference signal resource set corresponding to a first reconfigurable intelligent surface of the one or more reconfigurable intelligent surfaces associated with a first signature and a second group of resources of the channel state information reference signal resource set corresponding to a second reconfigurable intelligent surface of the one or more reconfigurable intelligent surfaces associated with a second signature, where the control signaling further indicates a first rank threshold corresponding to the first signature and a second rank threshold corresponding to the second signature, and where the indicated one or more communication beams may be based on the first rank threshold and the second rank threshold.

In some examples of the method, apparatuses, and non-transitory computer-readable medium described herein, the channel state information reference signal resource set corresponds to a first reconfigurable intelligent surface, and the control signaling further configures a second channel state information reference signal resource set corresponding to a second reconfigurable intelligent surface.

Some examples of the method, apparatuses, and non-transitory computer-readable medium described herein may further include operations, features, means, or instructions for communicating data with the UE via at least one reconfigurable intelligent surface of the one or more reconfigurable intelligent surfaces using the indicated one or more communication beams based on the channel state information report.

### BRIEF DESCRIPTION OF THE DRAWINGS

FIGS. 1 through 4 illustrate examples of wireless communications systems that support CSI reporting for RISs in accordance with aspects of the present disclosure.

FIG. 5 illustrates an example of a process flow that supports CSI reporting for RISs in accordance with aspects of the present disclosure.

FIGS. 6 and 7 show diagrams of devices that support CSI reporting for RISs in accordance with aspects of the present disclosure.

FIG. 8 shows a diagram of a communications manager that supports CSI reporting for RISs in accordance with aspects of the present disclosure.

FIG. 9 shows a diagram of a system including a device that supports CSI reporting for RISs in accordance with aspects of the present disclosure.

FIGS. 10 and 11 show diagrams of devices that support CSI reporting for RISs in accordance with aspects of the present disclosure.

FIG. 12 shows a diagram of a communications manager that supports CSI reporting for RISs in accordance with aspects of the present disclosure.

FIG. 13 shows a diagram of a system including a device that supports CSI reporting for RISs in accordance with aspects of the present disclosure.

FIGS. 14 through 17 show flowcharts illustrating methods that support CSI reporting for RISs in accordance with aspects of the present disclosure.

### DETAILED DESCRIPTION

Some wireless communications systems may support beamforming techniques for communications between wireless devices. However, physical proximity or environmental factors (e.g., interference, blockages) may impair beamformed communications between wireless devices. In some cases, wireless devices may be unable to successfully transmit information via a line-of-sight (LOS) path. For example, an LOS path (e.g., a straight line) between a base station and a UE may be obstructed. In some such cases, the base station may transmit information to the UE by reflecting a transmission off a reflective or semi-reflective surface. Some wireless communications systems may include RISs to reflect transmissions between wireless devices according to specific reflection angles. For example, a RIS may include a quantity of reflective, electrically-controllable elements. The RIS elements may be configured to reflect transmissions in a specific direction and, in some cases, a wireless network may configure the RIS elements to modify one or more reflection angles for one or more RIS elements. For example, a RIS may reflect a beamformed communication at an angle different from an angle of incidence (e.g., the angle at which the RIS received the beamformed communication). In some cases, a RIS may be self-contained (e.g., a standalone RIS) or may be associated with (e.g., paired with) some other wireless device (e.g., a RIS-enabled UE). In some cases, beamformed communications reflected by a RIS may be referred to as RIS-aided communications or RIS-aided transmissions.

A RIS may be capable of reflecting one beamformed signal at a time or may be capable of reflecting multiple beamformed signals concurrently. Additionally or alternatively, a base station may utilize a single RIS or may use a combination of multiple RISs to reflect multiple beamformed signals (e.g., concurrently). If a RIS does not support concurrently reflecting multiple beams, a base station may transmit information to the RIS using a single beam, and the RIS may reflect the beam at varying angles at different times (e.g., the RIS may perform a beam sweep) based on different configurations of the RIS elements at the different times. A UE may detect multiple reflected beams from the RIS at the different times, which may introduce challenges for CSI reporting procedures. For example, the base station may transmit signals to the RIS using one beam directed towards the RIS, and the UE may detect multiple signals reflected at different reflection angles during different time periods based on the one beam. The UE may determine that these signals received at different reflection angles correspond to different beams, despite the signals being based on a single beam used by the base station to transmit to the RIS. In some cases, the UE may erroneously report CSI for each reflected signal received by the UE, even if the reflected signals correspond to (e.g., are derived from) the same beam used by the base station. Additionally or alternatively, the base station may transmit signals to multiple RISs using multiple beams, and the multiple RISs may concurrently reflect the beamformed signals to a single UE. However, the UE may not be configured to effectively manage CSI reporting for beams reflected by different RISs (e.g., the UE may fail to determine which beams can be used concurrently for communications). Similarly, a RIS may support reflecting multiple beams concurrently. In some examples, a base station may transmit, to a single RIS, signals using multiple beams. The RIS may concurrently reflect the multiple beams, and a UE may concurrently receive the signals via the multiple beams. However, the UE may not be configured to effectively manage CSI reporting for beams concurrently reflected by a single RIS (e.g., the UE may fail to determine which beams can be used concurrently for communications).

Various aspects of the present disclosure relate to improved techniques for CSI reporting for RISs. For example, a base station may configure CSI-RS resource sets such that a UE may perform CSI reporting to effectively manage beamformed communications via one or more RISs. In some examples, the base station may define a CSI-RS resource set specific to a RIS. For example, the base station may transmit control signaling to a UE indicating a first CSI-RS resource set specific to a first RIS. If the base station may use a second RIS for communications with the UE, the base station may transmit control signaling indicating a second CSI-RS resource set specific to the second RIS to the UE. The CSI-RS resource set for a RIS may be based on whether the RIS can concurrently reflect multiple beamformed signals (e.g., whether the RIS includes multiple reflective elements that may operate concurrently, for example, with different reflection angles). The control signaling may include one or more of an indication of a threshold (e.g., maximum) rank of the CSI-RS resources, an indication of CSI-RS resources that can be concurrently scheduled (e.g., corresponding to concurrently reflected beams), or an indication of CSI-RS resources that cannot be concurrently scheduled, any of which may be referred to as a communication beam threshold. In some other examples, the base station may transmit control signaling indicating that a CSI-RS resource set corresponds to a group of RISs. For example, the base station may transmit, to a UE, an explicit indication of the resources corresponding to different RISs. Alternatively, the UE may implicitly determine the resources corresponding to different RISs based on MS signatures. The resource set may additionally include an indication that a UE may use CSI-RS resources concurrently (e.g., if multiple reflective elements or multiple RISs are used for CSI reporting). In some examples, the UE may transmit a CSI report indicating one or more beams (e.g., one or more beams selected for use in communications). Additionally or alternatively, the UE may select a precoder based on the one or more beams. For example, the UE may select a precoder corresponding to one or more beams indicated in the CSI report.

Aspects of the disclosure are initially described in the context of wireless communications systems. Aspects of the disclosure are further illustrated by and described with reference to diagrams of apparatuses, diagrams of systems, and flowcharts that relate to CSI reporting for RISs.

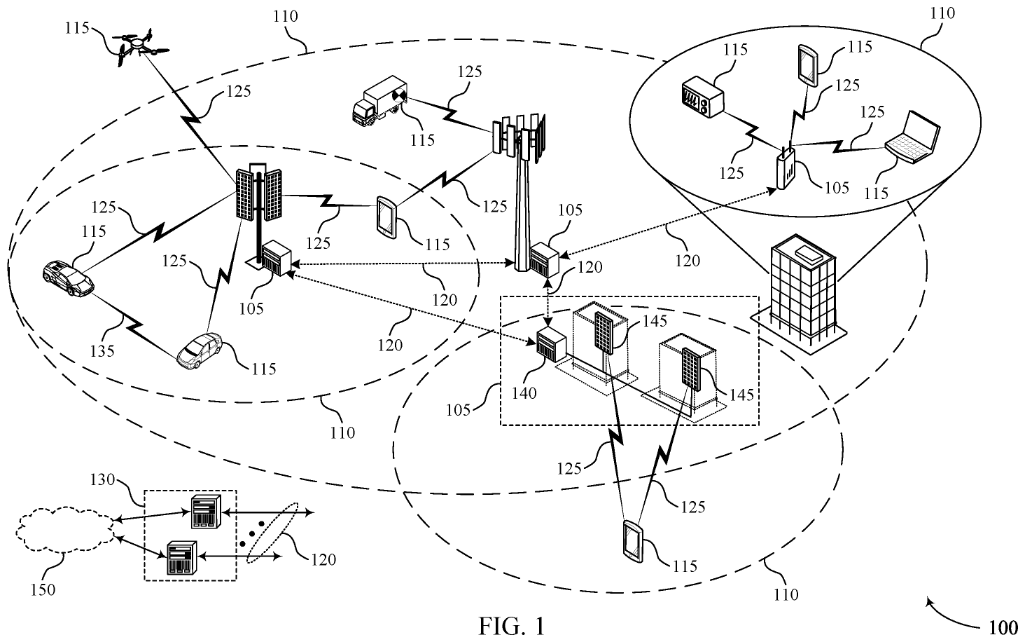

FIG. 1 illustrates an example of a wireless communications system 100 that supports channel state information reporting for reconfigurable intelligent surfaces in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation). A wireless device (e.g., a base station 105, a UE 115) may use precoding techniques to adjust the amplitude offsets, phase offsets, or both for the antenna elements to support beamforming. The wireless device may use CSI to perform precoding, for example, by setting or otherwise selecting a precoding matrix for transmission based on one or more CSI measurements.

A base station 105 or a UE 115 may use beam sweeping techniques as part of beamforming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may include or be an example of a precoding matrix indicator (PMI) or codebook-based feedback (e.g., a multi-panel type codebook, a linear combination type codebook, a port selection type codebook). Although techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data or control information to a receiving device).

A receiving device (e.g., a UE 115) may try multiple receive configurations (e.g., directional listening) when receiving various signals from a transmitting device (e.g., a base station 105), such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

Various aspects of the present disclosure relate to improved techniques for CSI reporting for RISs. For example, the wireless communications system 100 may include one or more RISs. A RIS may reflect a beamformed transmission for improved spatial diversity. For example, if there is an obstruction between a base station 105 and a UE 115, beamformed communications between the base station 105 and the UE 115 may be blocked (or otherwise result in relatively poor signal quality) due to the obstruction. A RIS may support communications between the base station 105 and the UE 115 by reflecting beamformed communications so as to avoid the obstruction. RISs may provide additional spatial diversity for communications while operating according to relatively low power overheads (e.g., below a threshold power level).

In some examples, a base station 105 may define one CSI-RS resource set per RIS. For example, the base station 105 may transmit control signaling to a UE 115 indicating a CSI-RS resource set specific to a RIS. The CSI-RS resource set may be configured based on whether the specific RIS can concurrently reflect multiple beamformed signals (e.g., whether the RIS includes multiple reflective elements that may operate concurrently with different reflection angles). The control signaling may include one or more of an indication of a threshold (e.g., maximum) rank of the CSI-RS resources, an indication of CSI-RS resources that can be concurrently scheduled (e.g., corresponding to concurrently reflected beams), or an indication of CSI-RS resources that cannot be concurrently scheduled. The UE 115 receiving the control signaling may use such indications to determine a quantity of communication beams to select for communications (e.g., concurrent communications for improved throughput). In some other examples, the base station 105 may transmit control signaling indicating a CSI-RS resource set corresponding to a group of RISs. For example, the base station 105 may transmit, to a UE 115, an indication of which resources of the CSI-RS resource set correspond to which RIS of a set of multiple RISs. Alternatively, the UE 115 may determine the resources corresponding to different RISs based on RIS signatures. In some examples, the UE 115 may transmit a CSI report indicating one or more communication beams (e.g., one or more beams selected for communications) based on CSI-RSs received in a configured CSI-RS resource set. Additionally or alternatively, the UE 115 may select a precoder based on the one or more communication beams. For example, the UE 115 may select a precoder (e.g., indicated by a precoding matrix indicator (PMI) value) corresponding to one or more communication beams indicated in the CSI report. The UE 115 may further include the PMI value in the CSI report.

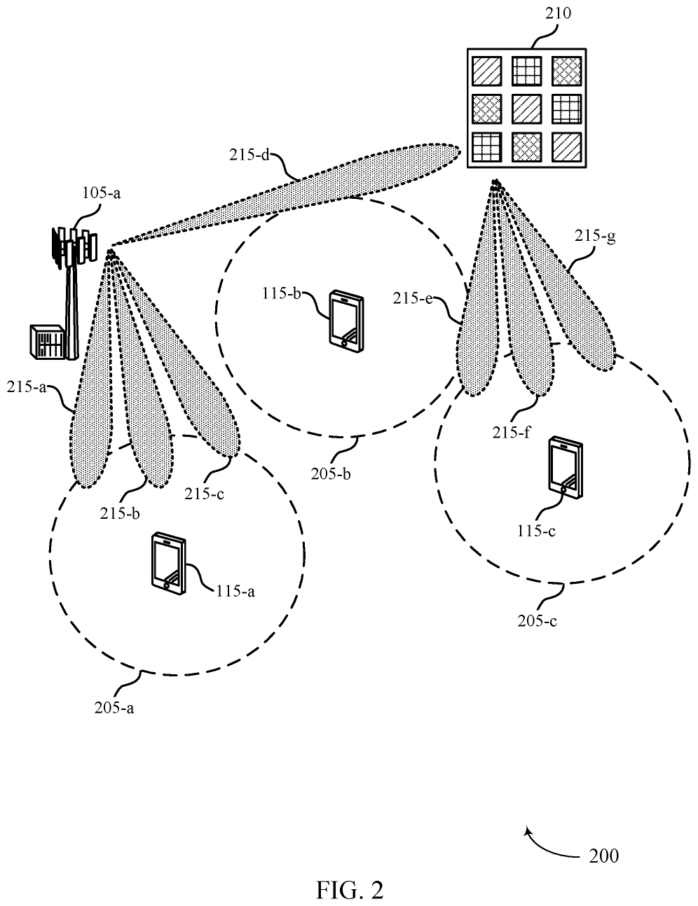

FIG. 2 illustrates an example of a wireless communications system 200 that supports CSI reporting for RISs in accordance with aspects of the present disclosure. The wireless communications system 200 may implement aspects of a wireless communications system 100. For example, the wireless communications system 200 may include base station 105-a, UE 115-a, UE 115-b, and UE 115-c, which may be examples of a corresponding base station 105 and UEs 115 as described with reference to FIG. 1. In some examples, UEs 115 may detect transmissions within regions 205. For example, UE 115-a may detect beamformed signals transmitted towards region 205-a, UE 115-b may detect beamformed signals transmitted towards region 205-b, and UE 115-c may detect beamformed signals transmitted towards region 205-c.

In some examples, base station 105-a may transmit information to one or more UEs 115 using beamformed communications (e.g., messages sent using beams 215). In some examples, base station 105-a may use a quantity of beams 215 to sense a channel, transmit reference signals, or otherwise test a set of beams 215 to determine one or more beams 215 for communications. Beams 215 may be communication beams, which may be examples of transmit beams, receive beams, or both. Base station 105-a may determine a beam for communications with a UE 115. For example, base station 105-a may transmit CSI-RSs to UE 115-a using beam 215-a, beam 215-b, and beam 215-c. UE 115-a may receive CSI-RSs from base station 105-a and may measure CSI associated with each beam 215 (e.g., using measurements obtained by UE 115-a for CSI-RSs received via the different beams 215). For example, UE 115-a may measure a reference signal received power (RSRP) for a CSI-RS transmitted by base station 105-a using beam 215-a, an RSRP for a CSI-RS transmitted by base station 105-a using beam 215-b, and an RSRP for a CSI-RS transmitted by base station 105-a using beam 215-c. Additionally or alternatively, UE 115-a may measure other channel or signal metrics for the received CSI-RSs. UE 115-a may transmit feedback to base station 105-a including a CSI report based on the received CSI-RSs. UE 115-a may generate the CSI report to include CSI information specific to one beam 215 or to include CSI information for multiple beams 215. Base station 105-a may determine to use one or more beams 215 for communications with UE 115-a based on the CSI report from UE 115-a. For example, base station 105-a may determine to use beam 215-b for communications based on one or more CSI channel metrics for beam 215-b satisfying a threshold.

In some examples, physical proximity or environmental factors (e.g., interference from other devices, blockages due to obstructions) may impair beamformed communications between base station 105-a and a UE 115. In some examples, base station 105-a and may be unable to successfully transmit information to a UE 115 via an LOS path. For example, base station 105-a may be unable to transmit information directly to UE 115-c via an LOS path, for example, due to interference from UE 115-b, due to an obstruction—such as a building—between base station 105-a and UE 115-c, due to a physical distance between base station 105-a and UE 115-c, or due to any other factors affecting signal quality between base station 105-a and UE 115-c. In some such examples, base station 105-a may transmit information to UE 115-c by reflecting a transmission off of a reflective or semi-reflective surface, which may allow the transmission to reduce interference, avoid an obstruction, or otherwise improve the signal quality of the transmission between base station 105-a and UE 115-c.

In some examples, the wireless communications system 200 may include one or more RISs 210 to facilitate transmissions between wireless devices. For example, a RIS 210 may facilitate the transmission of beamformed communications between base station 105-a and UE 115-c. In some examples, RISs 210 may be deployed in cellular systems including LTE, 5G NR, and other cellular systems. A RIS 210 may include a quantity of reflective, electrically-controllable elements. Each element may have electromagnetic characteristics that are reconfigurable and that define how beamformed communications reflect off the element. For example, a reflection coefficient of a reflective element may determine a reflection angle (e.g., based on an angle of incidence) for an incoming signal and may be reconfigurable by the RIS 210 or by the wireless network (e.g., via control signaling by a base station 105, such as base station 105-a). In some examples, the reflective elements may be uniformly distributed. The RIS 210 may reflect transmissions in a specific direction (e.g., in a controlled manner) based on a combination of configured states of reflective elements. For example, the RIS 210 may receive a beamformed transmission from base station 105-a using beam 215-d at an angle of incidence and may reflect the beamformed transmission at a different angle according to a current configuration of the RIS 210 (or a current configuration of one or more specific elements of the RIS 210). The RIS 210 may alter one or more channel realizations in a controlled manner, which may enhance channel diversities. For example, the RIS 210 may alter a channel realization for a channel by changing a reflection angle and—accordingly—changing the channel quality, signal quality, signal direction, or a combination thereof for communications on the channel. Increased channel diversity (e.g., increased spatial diversity based on different beam 215 reflections and directions) may provide robustness to channel blocking and channel fading, which may provide advantages in the wireless communications system 200.

In some cases, a RIS 210 may be self-contained (e.g., the RIS 210 may be a standalone RIS) or may be associated with (e.g., paired with) some other wireless device (e.g., a RIS-enabled UE). In some examples, the RIS 210 may be capable of configuring a reflected beam direction and a reflected beam width, among other capabilities. The reflected beam direction, reflected beam width, or both may be based on the incoming beam direction (e.g., the direction of beam 215-d), the incoming beam width (e.g., the width of beam 215-d), or both.

In some examples, the RIS 210 may be capable of reflecting one beam 215 at a time or may be capable of reflecting multiple beams 215 concurrently. Base station 105-a may transmit signals to the RIS 210 using a single beam 215-d, and the RIS 210 may reflect the signals at varying angles at different time instances (e.g., the RIS 210 may perform a beam sweep). For example, the RIS 210 may reconfigure one or more RIS elements such that the RIS 210 reflects beam 215-d as beam 215-e at a first time period, as beam 215-f at a second time period, and as beam 215-g at a third time period. A UE 115 may detect different reflected beams 215 at different times, which may introduce challenges for CSI reporting procedures. For example, base station 105-a may transmit signals using beam 215-d to the RIS 210. The RIS 210 may reflect signals received via beam 215-d at different angles at different time instances. For example, a signal received via beam 215-d may be transmitted (e.g., reflected) by the RIS 210 via beam 215-e, beam 215-f, or beam 215-g based on a current configuration of the RIS 210. UE 115-c may receive signals via beam 215-e, beam 215-f, and beam 215-g at different time periods and may report CSI to base station 105-a for each reflected beam 215. However, beam 215-e, beam 215-f, and beam 215-g may each correspond to (e.g., may be derived from) the same beam 215-d from base station 105-a. If UE 115-c fails to determine that beam 215-e, beam 215-f, and beam 215-g correspond to a same base station beam 215-d, UE 115-c may introduce errors into CSI reporting, beam selection, or both.

Additionally or alternatively, a UE 115 may fail to determine if a beam 215 has been reflected by a MS 210. For example, base station 105-a may transmit a CSI-RS using beam 215-d, and the MS 210 may reflect the CSI-RS via a reflected beam 215-e. UE 115-b may detect transmissions (e.g., via beams 215) within region 205-b. UE 115-b may detect a CSI-RS via beam 215-d and a CSI-RS via beam 215-e (e.g., the same CSI-RS before and after reflection by the RIS 210). However, in some cases, UE 115-b may be unable to effectively manage CSI reporting for beam 215-d and beam 215-e. For example, UE 115-b may be unable to determine that one instance of the CSI-RS was received from base station 105-a and one instance of the CSI-RS was received via a reflection from the RIS 210.

Additionally or alternatively, base station 105-a may be unable to determine the location of a UE 115 based on an indication of a selected beam (e.g., in a CSI report). For example, UEs 115 may be located within regions 205. In some examples, the location of a UE 115 may change. For example, UE 115-c may move from region 205-c to region 205-b. Additionally or alternatively, a beam 215 may be detected in multiple regions 205. For example, UE 115-b may be located in region 205-b and may detect beam 215-d in region 205-b. Similarly, UE 115-c may be located in region 205-c and may detect beam 215-d in region 205-c (e.g., as reflected beam 215-f). In some examples, a UE 115 may report CSI for beam 215-d and base station 105-a may be unable to determine if the UE 115 is in region 205-b (e.g., detecting beam 215-d from base station 105-a) or region 205-c (e.g., detecting a reflection of beam 215-d from the RIS 210). In some examples, UE 115-b may be located in region 205-b and may transmit a CSI report to base station 105-a for beam 215-d. However, base station 105-a may erroneously determine that UE 115-b is in region 205-c. Accordingly, base station 105-a may steer beam 215-d to region 205-c via a reflection at the RIS 210. Base station 105-a may attempt to transmit data to UE 115-b in region 205-c using beam 215-d and one or more reflected beams 215 (e.g., reflected beam 215-f). However, UE 115-b may be located in region 205-b and control overhead of the RIS 210 may be wasted (or otherwise used inefficiently). Additionally or alternatively, the one or more beams 215 that are reflected by the RIS 210 may introduce interference at other UEs 115 (e.g., UEs 115 in region 205-c).

Various aspects of the present disclosure relate to improved techniques for CSI reporting for RISs. In some examples, base station 105-a may define a CSI-RS resource set specific to a MS 210. For example, base station 105-a may transmit control signaling to UE 115-c (e.g., directly or via a RIS 210). The control signaling may indicate a configuration for a CSI-RS resource set. The configuration for the CSI-RS resource set may be based on whether the RIS 210 can concurrently reflect multiple beams 215 (e.g., whether the RIS 210 includes multiple reflective elements that may operate concurrently with different reflective angles). In some examples, the RIS 210 may be unable to reflect multiple beams 215 concurrently. Base station 105-a may transmit control signaling to UE 115-c indicating a configuration for a CSI-RS resource set based on a determination that the RIS 210 is unable to reflect multiple beams 215 concurrently. For example, the configuration may indicate that UE 115-c may use one beam 215 reflected by the RIS 210 at a time (e.g., because the RIS 210 does not support reflecting multiple beams 215 concurrently). When reporting CSI, UEs 115 may use the indicated parameters (e.g., a communication beam threshold, such as a maximum of one beam being supported concurrently) and compute CSI, a PMI, a rank indicator (RI), or a combination thereof accordingly.

The control signaling may include an indication of a threshold (e.g., maximum) rank of the CSI-RS resources. A UE 115 may determine to transmit CSI for one or more beams 215 based on the indication of a threshold rank of CSI-RS resources. The threshold rank of the CSI-RS resources may correspond to a number of beams 215 used by base station 105-a. For example, base station 105-a may transmit control signaling indicating a configuration for a CSI-RS resource set and a communication beam threshold for the CSI-RS resource set using beam 215-d. The communication beam threshold may correspond to a rank threshold indicator for the CSI-RS resource set. For example, the control signaling may indicate that a rank threshold is one. The MS 210 may perform a beam sweep and may reflect beam 215-d as reflected beam 215-e, reflected beam 215-f, and reflected beam 215-g (e.g., at different time instances). UE 115-c may receive CSI-RSs via beam 215-e, beam 215-f, and beam 215-g. UE 115-c may receive the configuration for the CSI-RS resource set including the indication of the rank threshold for the CSI-RS resources. Based on the indication, UE 115-c may determine to transmit a CSI report to base station 105-a based on the indication that the rank threshold is one. For example, UE 115-c may select one beam 215 from the reflected beams 215 carrying the CSI-RSs (e.g., beam 215-f) based on the rank threshold of one and may transmit a CSI report for beam 215-f (e.g., indicating that UE 115-c is selecting one beam 215—beam 215-f—for communications based on the rank threshold) to base station 105-a.

The control signaling may additionally or alternatively include an indication of CSI-RS resources that can be concurrently scheduled (e.g., corresponding to concurrently reflected beams 215) or an indication of CSI-RS resources that cannot be concurrently scheduled (e.g., corresponding to different reflected beams 215 from the same source beam 215). In some examples, base station 105-a and UEs 115 may support the use of multiple beam polarizations (e.g., using differently polarized radio waves). For example, base station 105-a and UEs 115 may transmit and receive information via horizontally polarized beams 215, vertically polarized beams 215, or both. Base station 105-a and UEs 115 may support communicating information using multiple beams with multiple polarizations concurrently. In some examples, beams 215 may represent multiple beams (e.g., with different polarizations) transmitted in a same direction (e.g., with overlapping angles of transmission, angles of reflection, or both). For example, beam 215-d may include a horizontally polarized beam 215-d and a vertically polarized beam 215-d. In some examples, the control signaling may include an indication that CSI-RS resources associated with different polarizations of beam 215-d may be concurrently scheduled. For example, base station 105-a may concurrently transmit information using beam 215-d with a horizontal polarization and transmit information using beam 215-d with a vertical polarization. The RIS 210 may reflect the different beams 215-d associated with different polarizations concurrently. UE 115-c may receive the information via different beams 215 associated with different polarizations concurrently. Based on the indication that CSI-RS resources may be concurrently scheduled, UE 115-c may transmit a CSI report to base station 105-a for different polarizations of beams (e.g., different polarizations of beam 215-d that support concurrent communication).

In some cases, the control signaling may include an indication of CSI-RS resources that may not be concurrently scheduled. For example, the control signaling may include an indication that multiple polarizations of beam 215-d may not be scheduled concurrently. For example, base station 105-a may transmit information, at a first time instance, using beam 215-d with a vertical polarization. Base station 105-a may transmit information, at a second time instance, using beam 215-d with a horizontal polarization. Both instances of beam 215-d may be reflected by the RIS 210. In some examples, the control signaling may indicate that CSI-RS resources corresponding to the horizontally polarized instance of beam 215-d and the vertically polarized instance of beam 215-d may not be scheduled concurrently. Accordingly, UE 115-c may receive the indication and may transmit a CSI report indicating a selection of one of the polarized instances of beam 215-d (e.g., due to base station 105-a not supporting concurrent communications using the different polarized instances of beam 215-d).

Base station 105-a may receive the CSI report from UE 115-c and may communicate with UE 115-c based on the CSI report. For example, if UE 115-c indicates one beam 215 (e.g., beam 215-f) in the CSI report based on a beam threshold for the RIS 210, base station 105-a may communicate with UE 115-c using beam 215-f. In some examples, base station 105-a may configure the RIS 210 to reflect beam 215-d as beam 215-f to communicate with UE 115-c via the RIS 210. Alternatively, if UE 115-c indicates multiple beams 215 (e.g., beam 215-e and beam 215-f) in the CSI report based on a beam threshold for the RIS 210 (e.g., if the RIS 210 supports concurrently reflecting different information via different beams, such as beam 215-e and beam 215-f), base station 105-a may communicate with UE 115-c via the RIS 210 using beam 215-e and beam 215-f concurrently for improved data throughput.

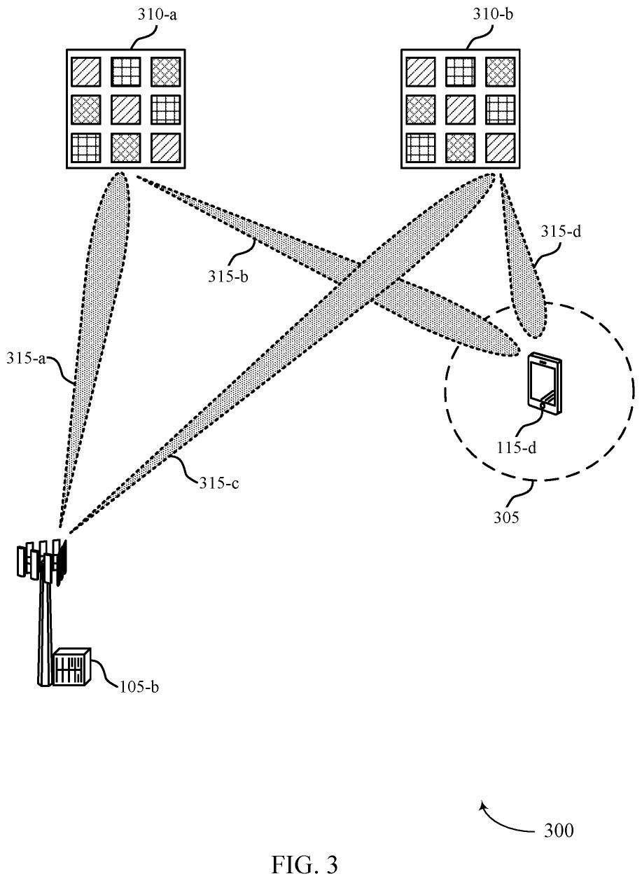

FIG. 3 illustrates an example of a wireless communications system 300 that supports CSI reporting for RISs in accordance with aspects of the present disclosure. The wireless communications system 300 may implement aspects of a wireless communications system 100 or 200. For example, the wireless communications system 300 may include base stations 105 and UEs 115, which may be examples of corresponding base stations 105 and UEs 115 as described with reference to FIGS. 1 and 2. UE 115-d may detect transmissions within a region 305, which may be an example of a region 205 as described with reference to FIG. 2. In some examples, base station 105-b may transmit information (e.g., data, control information, reference signals) to UE 115-d using beamformed communications (e.g., beams 315). In some examples, the beams 315 may be reflected by one or more RISs 310 (e.g., RIS 310-a and RIS 310-b) for improved spatial diversity within the wireless communications system 300.

In some examples, base station 105-b may utilize a combination of multiple RISs 310 (e.g., MS 310-a and RIS 310-b) to reflect multiple beams 315. RIS 310-a and MS 310-b may concurrently reflect beam 315-a and beam 315-c to UE 115-d (e.g., via beam 315-b and beam 315-d, respectively). However, in some cases, a UE 115 may not be configured to effectively manage CSI reporting for beams 315 concurrently reflected by multiple RISs 310 (e.g., a UE 115 may be unable to determine which beams 315 may be used concurrently for communications).

Various aspects of the present disclosure relate to improved techniques for CSI reporting for RISs 310. In some examples, base station 105-b may define (e.g., configure) a single CSI-RS resource set for reflections by multiple RISs 310. For example, base station 105-b may transmit, to UE 115-d, control signaling indicating a configuration for a CSI-RS resource set. The CSI-RS resource set may include resources in which UE 115-d is to receive CSI-RSs via RIS 310-a and other resources in which UE 115-d is to receive CSI-RSs via RIS 310-b.

In some examples, base station 105-b may explicitly indicate grouping of CSI-RS resources within the CSI-RS resource set that may be concurrently used. For example, base station 105-b may configure eight CSI-RS resources divided between RIS 310-a and RIS 310-b. Base station 105-b may dedicate (e.g., configure) CSI-RS resources one through four (or any quantity or configuration of the CSI-RS resources) for RIS 310-a and CSI-RS resources five through eight for RIS 310-b. In some examples, base station 105-b may indicate (e.g., in control signaling configuring the CSI-RS resource set) that CSI-RS resources one through four (e.g., resources configured for reflecting CSI-RSs via RIS 310-a) are included in a first group and CSI-RS resources five through eight (e.g., resources configured for reflecting CSI-RSs via RIS 310-b) are included in a second group. Accordingly, UE 115-d may determine that CSI-RSs received in resources from different groups correspond to different beams that may be used concurrently, while CSI-RSs received in resources from the same group (e.g., the first group corresponding to RIS 310-a) correspond to beams that may not be used concurrently (e.g., reflected beams 315 that correspond to a same source beam 315 from base station 105-b). Base station 105-d may additionally indicate CSI-RS resources that may be used concurrently. For example, base station 105-d may indicate that resources included in the first group may be used concurrently with resources included in the second group. That is, UE 115-d may concurrently report CSI for one CSI-RS resource from the first group and one CSI-RS resource from the second group. Such resources may correspond to one beam 315 reflected by MS 310-a (e.g., corresponding to the first group) and one beam 315 reflected by RIS 310-b (e.g., corresponding to the second group) that may be used concurrently.

In some other examples, UE 115-d may determine (e.g., derive) groupings of CSI-RS resources implicitly. For example, UE 115-d may determine a grouping of CSI-RS resources based on a signature introduced by a RIS 310. The signature may be an example of a RIS-specific signature and may be added to a packet header, added to data in a data stream, indicated using a specific encoding or encryption scheme, or otherwise indicated by a RIS 310. For example, base station 105-b may transmit information to UE 115-d using beam 315-a. Beam 315-b may result from the reflection of beam 315-a at RIS 310-a. RIS 310-a may add a RIS-specific signature to the information reflected via beam 315-b to indicate that the information has been reflected by RIS 310-a. Accordingly, UE 115-d may determine that beam 315-b is reflected by RIS 310-a based on the signature. In some examples, UE 115-d may determine whether to report CSI for a beam 315 based on the signature. For example, UE 115-d may receive a CSI-RS via beam 315-b, may detect a signature of RIS 310-a, and may determine that the CSI-RS resource is associated with a first group (e.g., a first group associated with RIS 310-a). Similarly, UE 115-d may receive a CSI-RS via beam 315-d, may detect a signature of RIS 310-b, and may determine that the CSI-RS resource is associated with a second group (e.g., a second group associated with RIS 310-b). UE 115-d may select one or more beams 315 for communications based on from which RIS 310 the beams 315 are reflected. For example, UE 115-d may request concurrent communications using beam 315-b and beam 315-d for spatial diversity and throughput gains because these beams 315 correspond to different RISs 310 (e.g., according to the different RIS signatures). In some examples, base station 105-b may indicate a rank threshold (e.g., CSI-RS resource rank restriction) based on a RIS signature. For example, a first RIS 310-a with a first RIS signature may support a first threshold rank, while a second RIS 310-b with a second RIS signature may support a second threshold rank. Alternatively, base station 105-b may indicate a rank threshold to be applied to each RIS 310. UE 115-d may determine how to report CSI based on the detected RIS signatures. For example, UE 115-d may transmit a CSI report indicating one or more beams 315 (e.g., beams 315 selected for communications) based on the received CSI-RSs and which CSI-RSs correspond to beams reflected by which RISs 310.

Additionally or alternatively, UE 115-d may select a precoder based on one or more beams 315 indicated in the CSI reporting, a quantity of RISs 310 used for communications, or both. For example, UE 115-d may determine a PMI value that is compatible with the rank selection by UE 115-d (e.g., based on a rank threshold configured for the CSI-RS resource set). If the beams 315 selected by UE 115-d for communication are reflected from a single RIS 310 (e.g., RIS 310-a), UE 115-d may select a coherent precoder and a corresponding PMI for the coherent precoder. If the beams 315 selected by UE 115-d for communication are reflected from multiple RISs 310 (e.g., RIS 310-a and RIS 310-b), UE 115-d may select a precoder that is coherent within each RIS 310 but may be assumed non-coherent across RISs 310 (e.g., supporting non-coherent precoding for beams 315 from different RISs 310). In some examples, if UE 115-d receives beams 315 from RIS 310-a and RIS 310-b, UE 115-d may select a precoder supporting coherent precoding for transmissions reflected by a single RIS 310, but may support non-coherent precoding for transmissions reflected by different RISs 310. UE 115-d may indicate the selected precoder to base station 105-b in the CSI reporting (e.g., using the PMI value).

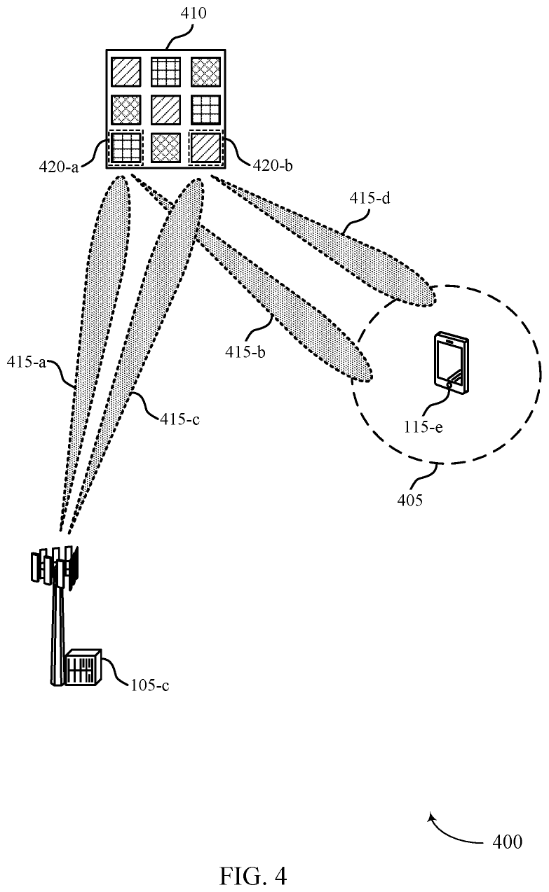

FIG. 4 illustrates an example of a wireless communications system 400 that supports CSI reporting for RISs in accordance with aspects of the present disclosure. The wireless communications system 400 may implement aspects of wireless communications systems 100, 200, or 300. For example, the wireless communications system 400 may include base stations 105 and UEs 115, which may be examples of corresponding base stations 105 and UEs 115 as described with reference to FIGS. 1 through 3. UE 115-e may detect signals within a region 405, which may be an example of a region 205 or a region 305 as described with reference to FIGS. 2 and 3. In some examples, base station 105-c may transmit information (e.g., data, control information, reference signals) to UE 115-e using beamformed communications (e.g., beams 415). In some examples, beams 415 may be reflected by a RIS 410 as described herein. The RIS 410 may include different portions 420 (e.g., different subsets of RIS elements) that may concurrently reflect beams in different directions. Accordingly, base station 105-c and UE 115-e may communicate via a specific portion 420 of the RIS 410 configured to reflect communications between base station 105-c and UE 115-e.

The RIS 410 may include multiple reflective elements and may be capable of controlling the multiple reflective elements to concurrently reflect transmissions. For example, the MS 410, base station 105-c, or another network entity may configure the reflective elements of the RIS 410 to support specific reflection directions, as well as other reflective parameters. Base station 105-c may concurrently transmit information to UE 115-e using beam 415-a and beam 415-c. The RIS 410 may reflect beam 415-a and beam 415-c as beam 415-b and beam 415-d, respectively. UE 115-e may receive information (e.g., CSI-RSs) via reflected beam 415-b and reflected beam 415-d concurrently.

Various aspects of the present disclosure relate to improved techniques for CSI reporting for RISs. In some examples, base station 105-c may define a CSI-RS resource set specific to the RIS 410. For example, base station 105-c may transmit, to UE 115-e, control signaling indicating a configuration for a CSI-RS resource set. The CSI-RS resource set may be based on whether a RIS 410 can concurrently reflect multiple beams 415 (e.g., whether the RIS 410 includes multiple reflective elements that may operate independently and concurrently with different reflective angles). For example, base station 105-c may define a CSI-RS resource set for the RIS 410. In some examples, the RIS 410 may be capable of reflecting multiple beams 415 concurrently using different portions of the RIS 410 (e.g., a first portion 420-a of the RIS 410 with a first reflection angle and a second portion 420-b of the RIS 410 with a second reflection angle). Base station 105-c may transmit, to UE 115-e, control signaling indicating the configuration for the CSI-RS resource set based on a determination that the RIS 410 supports reflecting multiple beams 415 concurrently (e.g., a threshold quantity of beams 415, such as two beams 415). When reporting CSI, UE 115-e may impose parameters indicated in the configuration (e.g., a threshold quantity of beams supported for concurrent communications via the RIS 410) and compute CSI, PMI, and RI accordingly.

The control signaling may include an indication of a threshold (e.g., maximum) rank of the CSI-RS resources. UE 115-e may determine to indicate one or more beams in one or more CSI reports based on the indication of the threshold rank of the CSI-RS resources. For example, UE 115-e may determine to transmit, to base station 105-c, a CSI report for beam 415-b and for beam 415-d.

In some examples, UE 115-e may select a precoder based on one or more communication beams selected for communication, a quantity of RISs 410 selected for communication, or both. For example, if UE 115-e receives information over multiple beams 415 reflected by a single RIS 410, UE 115-e may select a precoder that uses coherent precoding for the communications reflected by the RIS 410. UE 115-e may indicate the selected precoder to base station 105-c via CSI reporting. Additionally or alternatively, base station 105-c may use coherent precoding for transmissions reflected by the RIS 410 (e.g., based on the precoder selected by UE 115-e or based on a selection by base station 105-c). Accordingly, the precoder may be compatible with the rank of communications between base station 105-c and UE 115-e (e.g., rank two communications using two beams 415 reflected off different portions 420 of the RIS 410).

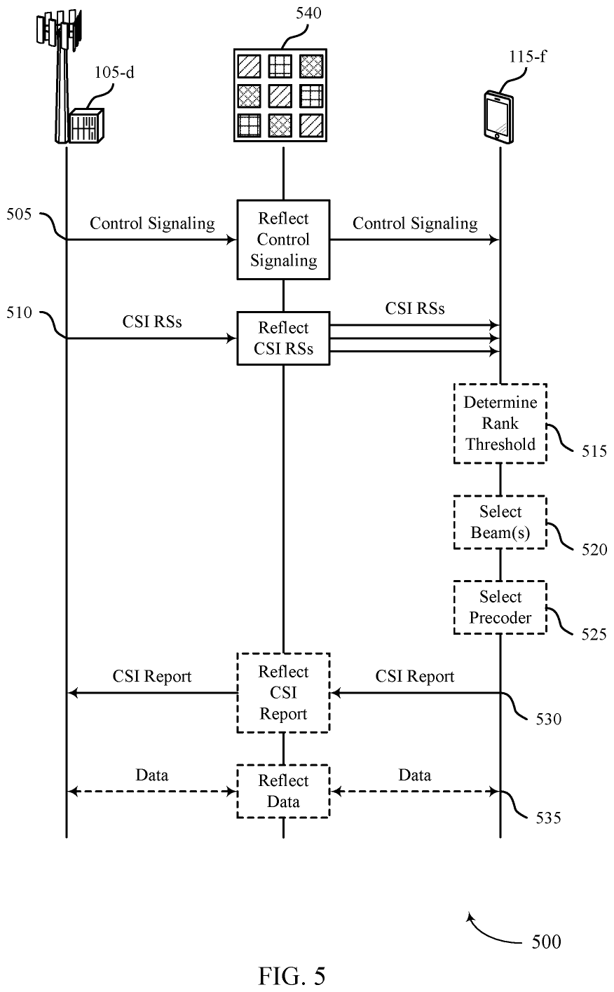

FIG. 5 illustrates an example of a process flow 500 that supports CSI reporting for RISs in accordance with aspects of the present disclosure. In some examples, the process flow 500 may implement aspects of a wireless communications system 100, 200, 300, or 400. For example, the process flow 500 may include base station 105-d, UE 115-f, and RIS 540, which may be examples of a corresponding base station, UE, and RIS as described with reference to FIGS. 1 through 4.

In the following description of the process flow 500, the operations between the base station 105-d, RIS 540, and UE 115-f may be performed in a different order than the order shown, or the operations may be performed at different times. Some operations may also be left out of the process flow 500, or other operations may be added to the process flow 500. While base station 105-d, RIS 540, and UE 115-f are shown performing a number of the operations of the process flow 500, any wireless devices may perform the operations described herein.

At 505, UE 115-f may receive control signaling indicating a configuration for a CSI-RS resource set and a communication beam threshold for the CSI-RS resource set. In some examples, base station 105-d may transmit the control signaling to the RIS 540, and the RIS 540 may reflect the control signaling to UE 115-f. The CSI-RS resource set may correspond to one or more RISs 540, and the communication beam threshold may be for the one or more RISs 540. For example, each RIS 540 may have a same communication beam threshold or RISs 540 may have RIS-specific communication beams thresholds. In some examples, the control signaling may include a rank threshold indicator for the CSI-RS resource set. Additionally or alternatively, the control signaling may include an indication of which resources of the CSI-RS resource set may be concurrently scheduled. Additionally or alternatively, the control signaling may include an indication of which resources of the CSI-RS resource set may not be concurrently scheduled. In some examples, the CSI-RS resource set may correspond to a first RIS 540. For example, the CSI-RS resource set may be specific to one RIS 540. In some such examples, the control signaling may further configure a second CSI-RS resource set corresponding to a second RIS 540. The communication beam threshold may be for both the first RIS and the second RIS (e.g., the communication beam threshold may be common across RISs), or the control signaling may further configure a second communication beam threshold for the second CSI-RS resource set. The communication beam threshold for a RIS 540 may be based on a concurrent beam transmission capability of the RIS 540.

At 510, UE 115-f may receive, according to the CSI-RS resource set, a set of CSI-RSs corresponding to a set of respective communication beams. For example, base station 105-d may transmit a CSI-RS in a resource of the CSI-RS resource set to the RIS 540, and the MS 540 may reflect the CSI-RS to UE 115-f. The CSI-RSs may support beam detection and selection at UE 115-f, such that UE 115-f may determine one or more beams supporting communications between UE 115-f and base station 105-d (e.g., beams with a highest quality metric or meeting a quality metric threshold). In some examples, the MS 540 may reflect CSI-RSs in different directions at different time instances (e.g., based on different configurations of the MS 540). If the CSI-RS resource set corresponds to multiple RISs, UE 115-f may determine that a first group of resources of the CSI-RS resource set corresponds to a first RIS 540 and a second group of resources of the CSI-RS resource set corresponds to a second MS 540 based on the control signaling. For example, in some cases, the control signaling may further indicate that the first group of resources corresponds to the first MS 540 and the second group of resources corresponds to the second MS 540. In some other cases, UE 115-f may detect, in a first set of CSI-RSs received in the first group of resources, a first signature associated with the first MS and may detect, in a second set of CSI-RSs received in the second group of resources, a second signature associated with the second MS, such that UE 115-f may determine which CSI-RS resources correspond to which MS 540 based on the signatures. The control signaling may further indicate a first rank threshold corresponding to the first signature and a second rank threshold corresponding to the second signature. In some examples, the first communication beam threshold may correspond to the first rank threshold and the second communication beam threshold may correspond to the second rank threshold.

At 515, UE 115-f may determine a rank threshold for the CSI-RS resource set based on the rank threshold indicator. In some examples, the communication beam threshold may correspond to the rank threshold. The rank threshold may indicate a threshold (e.g., maximum) number of beams that UE 115-f may use concurrently.

At 520, UE 115-f may select one or more communication beams based on which resources of the CSI-RS resource set may be concurrently scheduled. Alternatively, UE 115-f may select the one or more communication beams based on the indication of which resources of the CSI-RS resource set may not be concurrently scheduled. Additionally or alternatively, UE 115-f may select a first one or more communication beams based on the first group of resources and a first communication beam threshold and select a second one or more communication beams based on the second group of resources and a second communication beam threshold.

At 525, UE 115-f may select a precoder based on the one or more communication beams and a quantity of RISs 540 corresponding to the one or more communication beams. UE 115-f may indicate the selected precoder in a CSI report. In some examples, the precoder may support coherent precoding based on the one or more communication beams corresponding to one RIS 540. In some other examples, the precoder may support non-coherent precoding (e.g., across different RISs 540) based on the one or more communication beams corresponding to multiple RISs 540.

At 530, UE 115-f may transmit a CSI report indicating the one or more communication beams of the set of respective communication beams based on the set of CSI-RSs and based on the communication beam threshold. The CSI report may indicate the selected one or more communication beams for one or more RISs 540. At 535, UE 115-f may communicate data using the one or more communication beams based on the CSI report. In some examples, the MS 540 may reflect data communications between UE 115-f and base station 105-d.

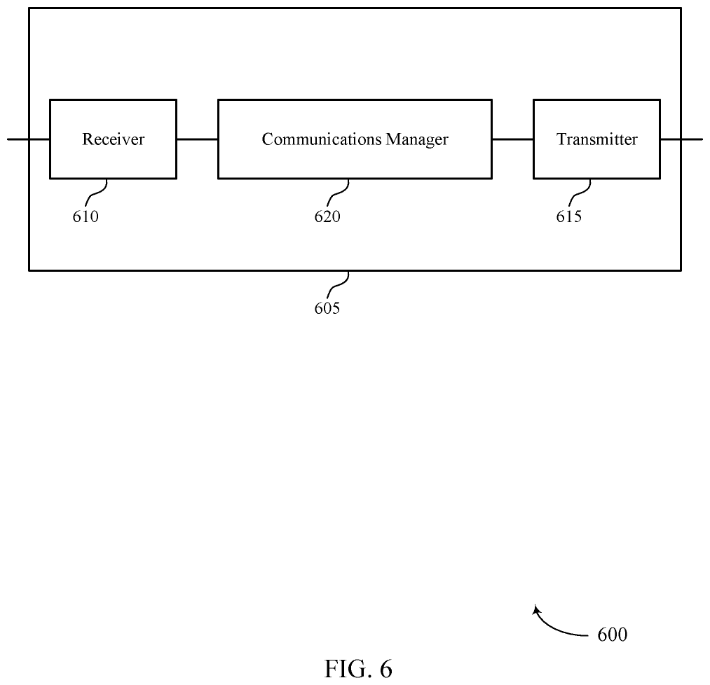

FIG. 6 shows a diagram 600 of a device 605 that supports CSI reporting for RISs in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to CSI reporting for RISs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CSI reporting for RISs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of CSI reporting for RISs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving control signaling indicating a configuration for a channel state information reference signal resource set corresponding to one or more reconfigurable intelligent surfaces and a communication beam threshold for the one or more reconfigurable intelligent surfaces. The communications manager 620 may be configured as or otherwise support a means for receiving, according to the channel state information reference signal resource set and via the one or more reconfigurable intelligent surfaces, a set of multiple channel state information reference signals corresponding to a set of multiple respective communication beams. The communications manager 620 may be configured as or otherwise support a means for transmitting a channel state information report indicating one or more communication beams of the set of multiple respective communication beams based on the set of multiple channel state information reference signals and on the communication beam threshold.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for improved communication reliability, more efficient utilization of communication resources, and improved coordination between devices. For example, the device 605 may support improved accuracy in CSI reporting based on the configuration for the CSI-RS resource set and the communication beam threshold. Such improved accuracy may allow the device 605 to reduce a number of times processing units ramp up power to support CSI reporting, reducing the processing overhead at the device 605. Additionally or alternatively, the one or more communication beams indicated in the CSI report may support concurrent communications for the device 605 (e.g., via one or more RISs, directly with a base station 105, or a combination thereof), improving data throughput and reducing an amount of time that the processing units of the device 605 remain powered on for handling wireless communications, further reducing the processing overhead at the device 605.

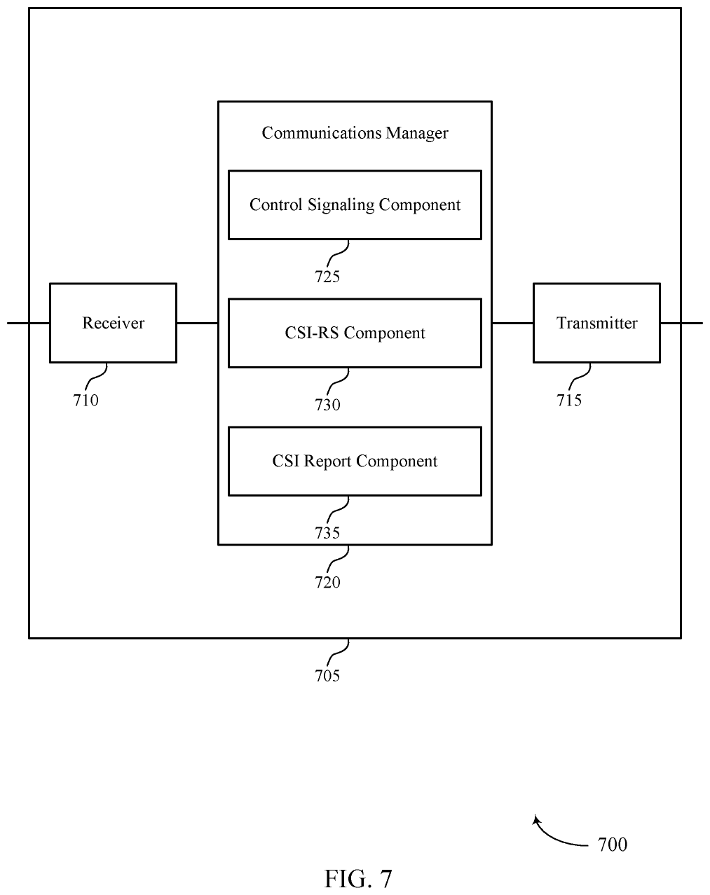

FIG. 7 shows a diagram 700 of a device 705 that supports CSI reporting for RISs in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CSI reporting for RISs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CSI reporting for RISs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of CSI reporting for RISs as described herein. For example, the communications manager 720 may include a control signaling component 725, a CSI-RS component 730, a CSI report component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The control signaling component 725 may be configured as or otherwise support a means for receiving control signaling indicating a configuration for a channel state information reference signal resource set corresponding to one or more reconfigurable intelligent surfaces and a communication beam threshold for the one or more reconfigurable intelligent surfaces. The CSI-RS component 730 may be configured as or otherwise support a means for receiving, according to the channel state information reference signal resource set and via the one or more reconfigurable intelligent surfaces, a set of multiple channel state information reference signals corresponding to a set of multiple respective communication beams. The CSI report component 735 may be configured as or otherwise support a means for transmitting a channel state information report indicating one or more communication beams of the set of multiple respective communication beams based on the set of multiple channel state information reference signals and on the communication beam threshold.

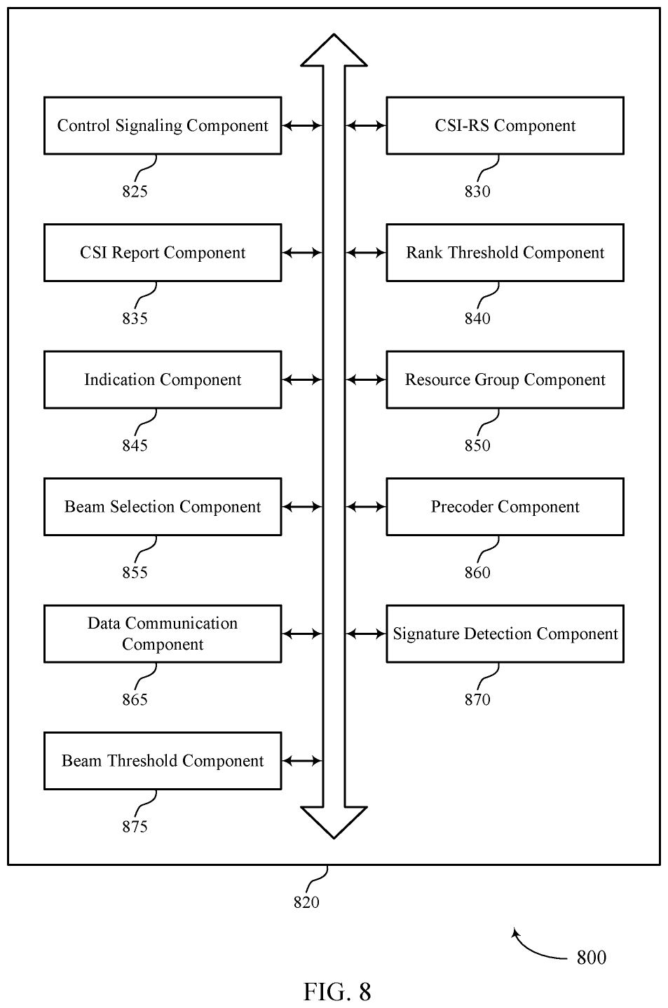

FIG. 8 shows a diagram 800 of a communications manager 820 that supports CSI reporting for RISs in accordance with aspects of the present disclosure. The communications manager 820 may be an example of aspects of a communications manager 620, a communications manager 720, or both, as described herein. The communications manager 820, or various components thereof, may be an example of means for performing various aspects of CSI reporting for RISs as described herein. For example, the communications manager 820 may include a control signaling component 825, a CSI-RS component 830, a CSI report component 835, a rank threshold component 840, an indication component 845, a resource group component 850, a beam selection component 855, a precoder component 860, a data communication component 865, a signature detection component 870, a beam threshold component 875, or any combination thereof. Each of these components may communicate, directly or indirectly, with one another (e.g., via one or more buses).

The communications manager 820 may support wireless communications at a UE in accordance with examples as disclosed herein. The control signaling component 825 may be configured as or otherwise support a means for receiving control signaling indicating a configuration for a channel state information reference signal resource set corresponding to one or more reconfigurable intelligent surfaces and a communication beam threshold for the one or more reconfigurable intelligent surfaces. The CSI-RS component 830 may be configured as or otherwise support a means for receiving, according to the channel state information reference signal resource set and via the one or more reconfigurable intelligent surfaces, a set of multiple channel state information reference signals corresponding to a set of multiple respective communication beams. The CSI report component 835 may be configured as or otherwise support a means for transmitting a channel state information report indicating one or more communication beams of the set of multiple respective communication beams based on the set of multiple channel state information reference signals and on the communication beam threshold.

In some examples, the control signaling includes a rank threshold indicator for the channel state information reference signal resource set, and the rank threshold component 840 may be configured as or otherwise support a means for determining a rank threshold for the one or more reconfigurable intelligent surfaces based on the rank threshold indicator, the communication beam threshold corresponding to the rank threshold.

In some examples, the control signaling includes an indication of which resources of the channel state information reference signal resource set may be concurrently scheduled, and the indication component 845 may be configured as or otherwise support a means for selecting the one or more communication beams based on the indication of which resources of the channel state information reference signal resource set may be concurrently scheduled, where the channel state information report is based on the selecting.

In some examples, the control signaling includes an indication of which resources of the channel state information reference signal resource set may not be concurrently scheduled, and the indication component 845 may be configured as or otherwise support a means for selecting the one or more communication beams based on the indication of which resources of the channel state information reference signal resource set may not be concurrently scheduled, where the channel state information report is based on the selecting.

In some examples, the resource group component 850 may be configured as or otherwise support a means for determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces. In some examples, the beam selection component 855 may be configured as or otherwise support a means for selecting a first one or more communication beams based on the first group of resources and a first communication beam threshold and selecting a second one or more communication beams based on the second group of resources and a second communication beam threshold, where the channel state information report is based on the selecting the first one or more communication beams and selecting the second one or more communication beams.

In some examples, the control signaling further indicates the first group of resources and the second group of resources, where the determining is based on the control signaling.

In some examples, the signature detection component 870 may be configured as or otherwise support a means for detecting, in a first set of channel state information reference signals of the set of multiple channel state information reference signals received in the first group of resources, a first signature associated with the first reconfigurable intelligent surface and detecting, in a second set of channel state information reference signals of the set of multiple channel state information reference signals received in the second group of resources, a second signature associated with the second reconfigurable intelligent surface, where the determining is based on detecting the first signature and detecting the second signature.

In some examples, the control signaling further indicates a first rank threshold corresponding to the first signature and a second rank threshold corresponding to the second signature, the first communication beam threshold corresponding to the first rank threshold and the second communication beam threshold corresponding to the second rank threshold.

In some examples, the channel state information reference signal resource set corresponds to a first reconfigurable intelligent surface. In some examples, the control signaling further configures a second channel state information reference signal resource set corresponding to a second reconfigurable intelligent surface. In some examples, the communication beam threshold is for both the first reconfigurable intelligent surface and the second reconfigurable intelligent surface. In some other examples, the communication beam threshold is for the first reconfigurable intelligent surface and the control signaling further configures a second communication beam threshold for the second reconfigurable intelligent surface. In some examples, the communication beam threshold is based on a concurrent beam transmission capability of the first reconfigurable intelligent surface.

In some examples, the precoder component 860 may be configured as or otherwise support a means for selecting a precoder based on the one or more communication beams and a quantity of reconfigurable intelligent surfaces corresponding to the one or more communication beams, where the channel state information report further indicates the selected precoder. In some examples, the precoder supports coherent precoding based on the one or more communication beams corresponding to one reconfigurable intelligent surface. In some other examples, the precoder supports non-coherent precoding based on the one or more communication beams corresponding to a set of multiple reconfigurable intelligent surfaces.

In some examples, the data communication component 865 may be configured as or otherwise support a means for communicating data with a base station via at least one reconfigurable intelligent surface of the one or more reconfigurable intelligent surfaces using the one or more communication beams based on the channel state information report.

In some examples, the channel state information report is transmitted via at least one reconfigurable intelligent surface of the one or more reconfigurable intelligent surfaces.

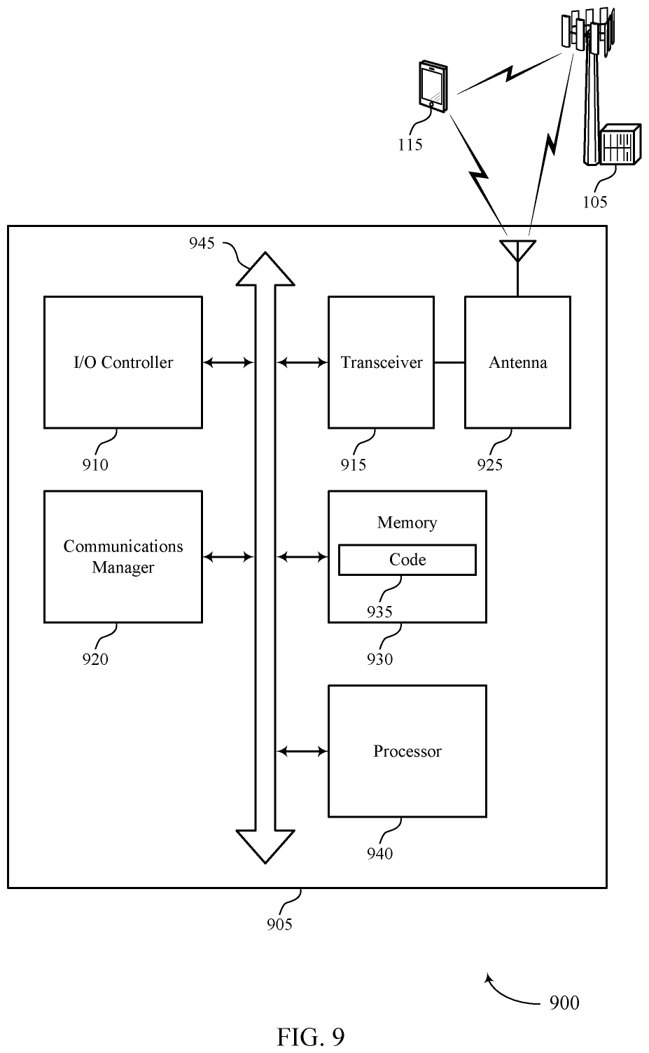

FIG. 9 shows a diagram of a system 900 including a device 905 that supports CSI reporting for RISs in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting CSI reporting for RISs). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving control signaling indicating a configuration for a channel state information reference signal resource set corresponding to one or more reconfigurable intelligent surfaces and a communication beam threshold for the one or more reconfigurable intelligent surfaces. The communications manager 920 may be configured as or otherwise support a means for receiving, according to the channel state information reference signal resource set and via the one or more reconfigurable intelligent surfaces, a set of multiple channel state information reference signals corresponding to a set of multiple respective communication beams. The communications manager 920 may be configured as or otherwise support a means for transmitting a channel state information report indicating one or more communication beams of the set of multiple respective communication beams based on the set of multiple channel state information reference signals and on the communication beam threshold.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of CSI reporting for RISs as described herein, or the processor 940 and the memory 930 may be otherwise configured to perform or support such operations.

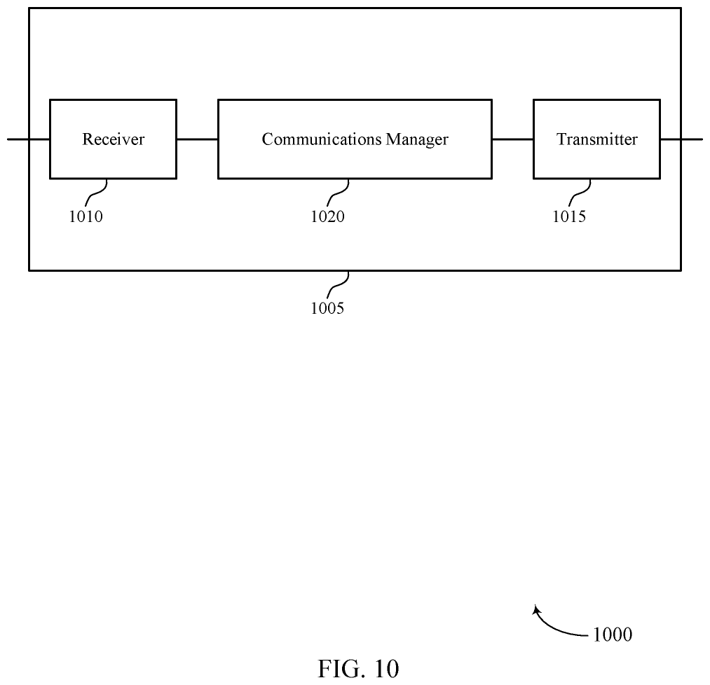

FIG. 10 shows a diagram 1000 of a device 1005 that supports CSI reporting for RISs in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to CSI reporting for RISs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to CSI reporting for RISs). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of CSI reporting for RISs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, control signaling indicating a configuration for a channel state information reference signal resource set corresponding to one or more reconfigurable intelligent surfaces and a communication beam threshold for the one or more reconfigurable intelligent surfaces. The communications manager 1020 may be configured as or otherwise support a means for transmitting, to the UE via the one or more reconfigurable intelligent surfaces and according to the channel state information reference signal resource set, a set of multiple channel state information reference signals corresponding to a set of multiple respective communication beams. The communications manager 1020 may be configured as or otherwise support a means for receiving, from the UE, a channel state information report indicating one or more communication beams of the set of multiple respective communication beams based on the set of multiple channel state information reference signals and on the communication beam threshold.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for improved communication reliability, more efficient utilization of communication resources, and improved coordination between devices.

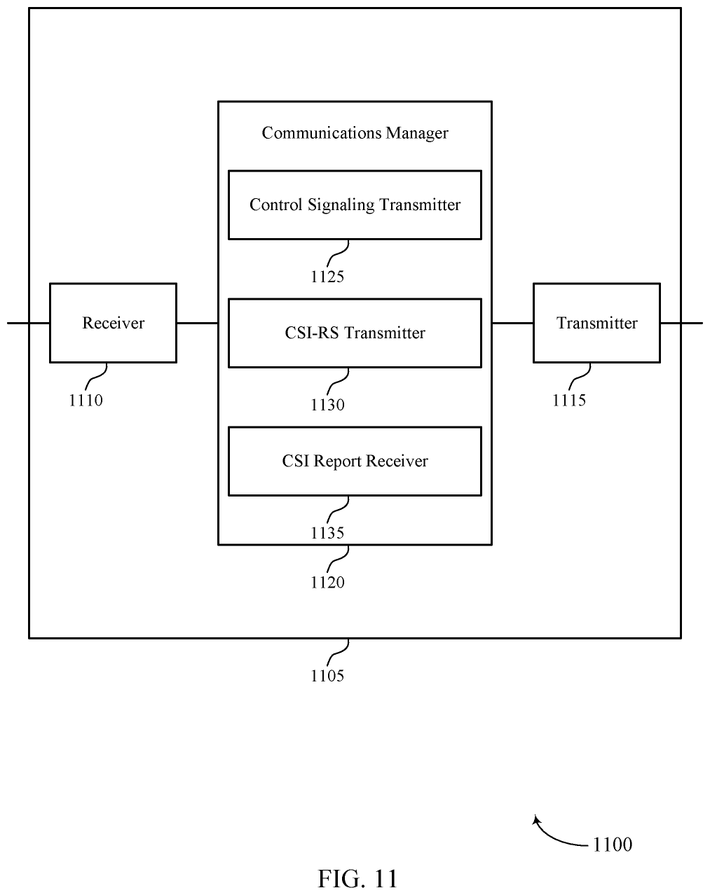

FIG. 11 shows a diagram 1100 of a device 1105 that supports CSI reporting for RISs in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to CSI reporting for RISs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to CSI reporting for RISs). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of CSI reporting for RISs as described herein. For example, the communications manager 1120 may include a control signaling transmitter 1125, a CSI-RS transmitter 1130, a CSI report receiver 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The control signaling transmitter 1125 may be configured as or otherwise support a means for transmitting, to a UE, control signaling indicating a configuration for a channel state information reference signal resource set corresponding to one or more reconfigurable intelligent surfaces and a communication beam threshold for the one or more reconfigurable intelligent surfaces. The CSI-RS transmitter 1130 may be configured as or otherwise support a means for transmitting, to the UE via the one or more reconfigurable intelligent surfaces and according to the channel state information reference signal resource set, a set of multiple channel state information reference signals corresponding to a set of multiple respective communication beams. The CSI report receiver 1135 may be configured as or otherwise support a means for receiving, from the UE, a channel state information report indicating one or more communication beams of the set of multiple respective communication beams based on the set of multiple channel state information reference signals and on the communication beam threshold.

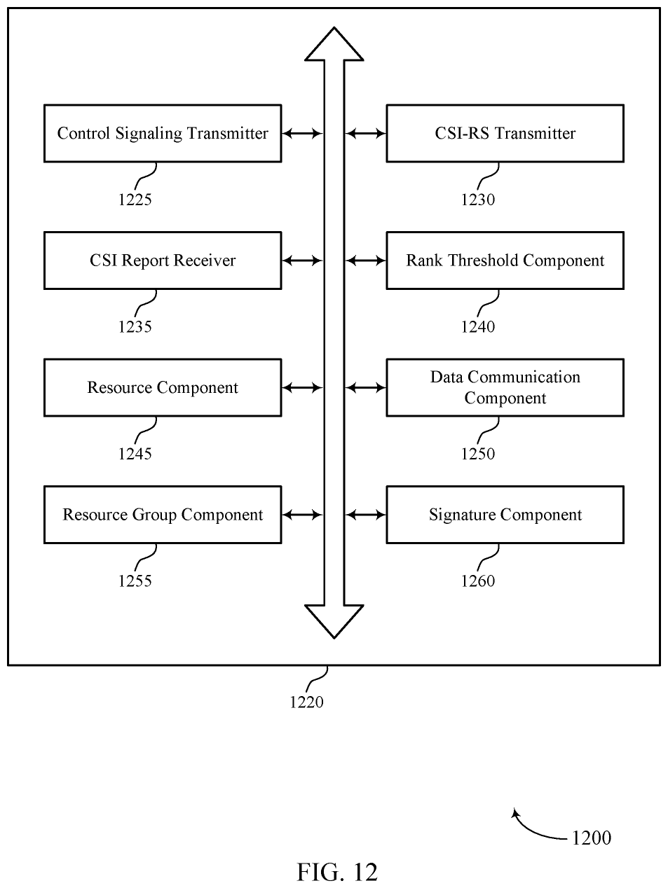

FIG. 12 shows a diagram 1200 of a communications manager 1220 that supports CSI reporting for RISs in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of CSI reporting for RISs as described herein. For example, the communications manager 1220 may include a control signaling transmitter 1225, a CSI-RS transmitter 1230, a CSI report receiver 1235, a rank threshold component 1240, a resource component 1245, a data communication component 1250, a resource group component 1255, a signature component 1260, or any combination thereof. Each of these components may communicate, directly or indirectly, with one another (e.g., via one or more buses).

The communications manager 1220 may support wireless communications at a base station in accordance with examples as disclosed herein. The control signaling transmitter 1225 may be configured as or otherwise support a means for transmitting, to a UE, control signaling indicating a configuration for a channel state information reference signal resource set corresponding to one or more reconfigurable intelligent surfaces and a communication beam threshold for the one or more reconfigurable intelligent surfaces. The CSI-RS transmitter 1230 may be configured as or otherwise support a means for transmitting, to the UE via the one or more reconfigurable intelligent surfaces and according to the channel state information reference signal resource set, a set of multiple channel state information reference signals corresponding to a set of multiple respective communication beams. The CSI report receiver 1235 may be configured as or otherwise support a means for receiving, from the UE, a channel state information report indicating one or more communication beams of the set of multiple respective communication beams based on the set of multiple channel state information reference signals and on the communication beam threshold.

In some examples, the rank threshold component 1240 may be configured as or otherwise support a means for determining a rank threshold for the channel state information reference signal resource set based on an association between the set of multiple channel state information reference signals and the one or more reconfigurable intelligent surfaces, where the control signaling includes a rank threshold indicator indicating the rank threshold, and where the indicated one or more communication beams are based on the rank threshold.

In some examples, the resource component 1245 may be configured as or otherwise support a means for determining which resources of the channel state information reference signal resource set may be concurrently scheduled based on an association between the set of multiple channel state information reference signals and the one or more reconfigurable intelligent surfaces, where the control signaling includes an indication of which resources of the channel state information reference signal resource set may be concurrently scheduled, and where the indicated one or more communication beams are based on the indication.

In some examples, the resource component 1245 may be configured as or otherwise support a means for determining which resources of the channel state information reference signal resource set may not be concurrently scheduled based on an association between the set of multiple channel state information reference signals and the one or more reconfigurable intelligent surfaces, where the control signaling includes an indication of which resources of the channel state information reference signal resource set may not be concurrently scheduled, and where the indicated one or more communication beams are based on the indication.

In some examples, the resource group component 1255 may be configured as or otherwise support a means for determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces, where the control signaling further indicates the first group of resources and the second group of resources, and where the indicated one or more communication beams are based on the first group of resources and the second group of resources.

In some examples, the signature component 1260 may be configured as or otherwise support a means for determining a first group of resources of the channel state information reference signal resource set corresponding to a first reconfigurable intelligent surface of the one or more reconfigurable intelligent surfaces associated with a first signature and a second group of resources of the channel state information reference signal resource set corresponding to a second reconfigurable intelligent surface of the one or more reconfigurable intelligent surfaces associated with a second signature, where the control signaling further indicates a first rank threshold corresponding to the first signature and a second rank threshold corresponding to the second signature, and where the indicated one or more communication beams are based on the first rank threshold and the second rank threshold.

In some examples, the channel state information reference signal resource set corresponds to a first reconfigurable intelligent surface. In some examples, the control signaling further configures a second channel state information reference signal resource set corresponding to a second reconfigurable intelligent surface.

In some examples, the data communication component 1250 may be configured as or otherwise support a means for communicating data with the UE via at least one reconfigurable intelligent surface of the one or more reconfigurable intelligent surfaces using the indicated one or more communication beams based on the channel state information report.

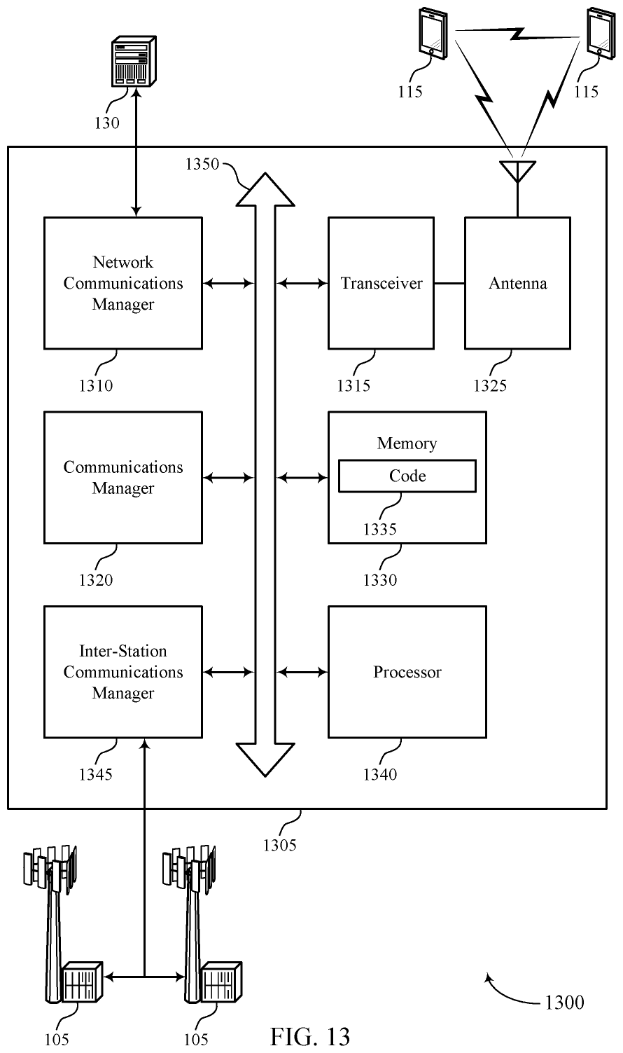

FIG. 13 shows a diagram of a system 1300 including a device 1305 that supports CSI reporting for RISs in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting CSI reporting for RISs). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, control signaling indicating a configuration for a channel state information reference signal resource set corresponding to one or more reconfigurable intelligent surfaces and a communication beam threshold for the one or more reconfigurable intelligent surfaces. The communications manager 1320 may be configured as or otherwise support a means for transmitting, to the UE via the one or more reconfigurable intelligent surfaces and according to the channel state information reference signal resource set, a set of multiple channel state information reference signals corresponding to a set of multiple respective communication beams. The communications manager 1320 may be configured as or otherwise support a means for receiving, from the UE, a channel state information report indicating one or more communication beams of the set of multiple respective communication beams based on the set of multiple channel state information reference signals and on the communication beam threshold.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of CSI reporting for RISs as described herein, or the processor 1340 and the memory 1330 may be otherwise configured to perform or support such operations.

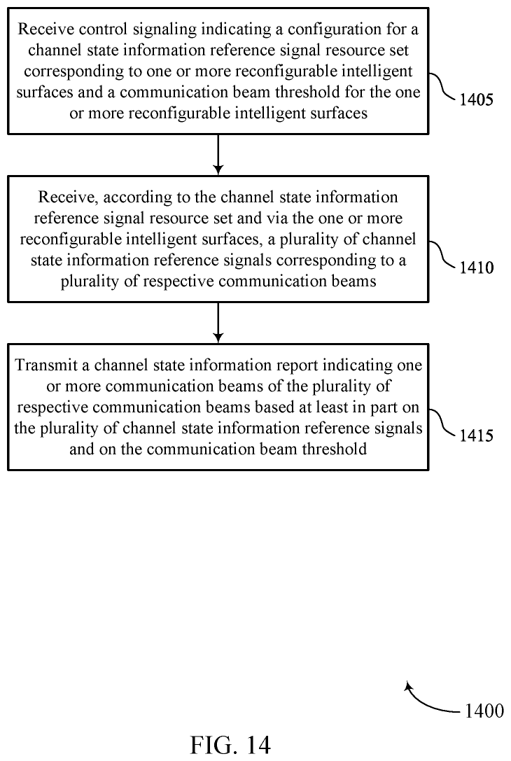

FIG. 14 shows a flowchart illustrating a method 1400 that supports CSI reporting for RISs in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving control signaling indicating a configuration for a channel state information reference signal resource set corresponding to one or more reconfigurable intelligent surfaces and a communication beam threshold for the one or more reconfigurable intelligent surfaces. The operations of 1405 may be performed in accordance with examples as disclosed herein. In some examples, aspects of the operations of 1405 may be performed by a control signaling component 825 as described with reference to FIG. 8.

At 1410, the method may include receiving, according to the channel state information reference signal resource set and via the one or more reconfigurable intelligent surfaces, a set of multiple channel state information reference signals corresponding to a set of multiple respective communication beams. The operations of 1410 may be performed in accordance with examples as disclosed herein. In some examples, aspects of the operations of 1410 may be performed by a CSI-RS component 830 as described with reference to FIG. 8.

At 1415, the method may include transmitting a channel state information report indicating one or more communication beams of the set of multiple respective communication beams based on the set of multiple channel state information reference signals and on the communication beam threshold. The operations of 1415 may be performed in accordance with examples as disclosed herein. In some examples, aspects of the operations of 1415 may be performed by a CSI report component 835 as described with reference to FIG. 8.

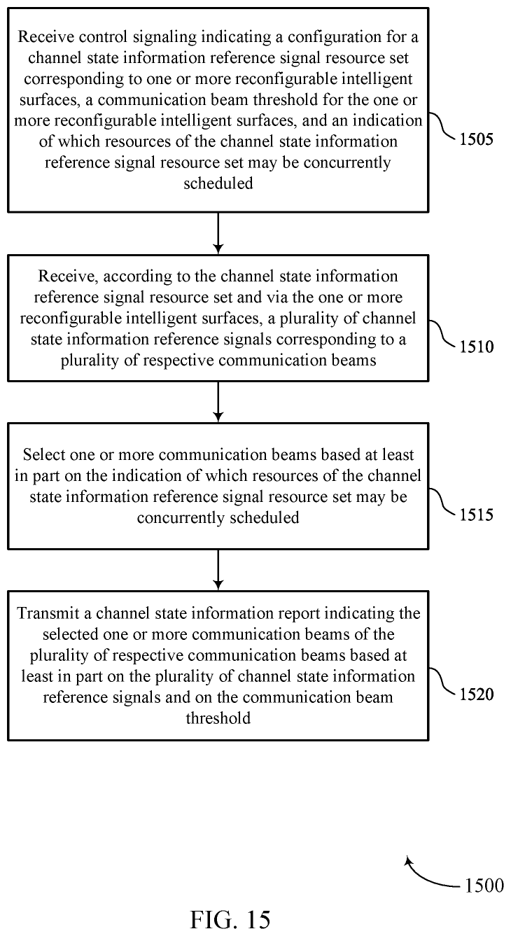

FIG. 15 shows a flowchart illustrating a method 1500 that supports CSI reporting for RISs in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving control signaling indicating a configuration for a channel state information reference signal resource set corresponding to one or more reconfigurable intelligent surfaces, a communication beam threshold for the one or more reconfigurable intelligent surfaces, and an indication of which resources of the channel state information reference signal resource set may be concurrently scheduled. The operations of 1505 may be performed in accordance with examples as disclosed herein. In some examples, aspects of the operations of 1505 may be performed by a control signaling component 825 as described with reference to FIG. 8.

At 1510, the method may include receiving, according to the channel state information reference signal resource set and via the one or more reconfigurable intelligent surfaces, a set of multiple channel state information reference signals corresponding to a set of multiple respective communication beams. The operations of 1510 may be performed in accordance with examples as disclosed herein. In some examples, aspects of the operations of 1510 may be performed by a CSI-RS component 830 as described with reference to FIG. 8.

At 1515, the method may include selecting one or more communication beams based on the indication of which resources of the channel state information reference signal resource set may be concurrently scheduled. The operations of 1515 may be performed in accordance with examples as disclosed herein. In some examples, aspects of the operations of 1515 may be performed by an indication component 845 as described with reference to FIG. 8.

At 1520, the method may include transmitting a channel state information report indicating the selected one or more communication beams of the set of multiple respective communication beams based on the set of multiple channel state information reference signals and on the communication beam threshold. The operations of 1520 may be performed in accordance with examples as disclosed herein. In some examples, aspects of the operations of 1520 may be performed by a CSI report component 835 as described with reference to FIG. 8.

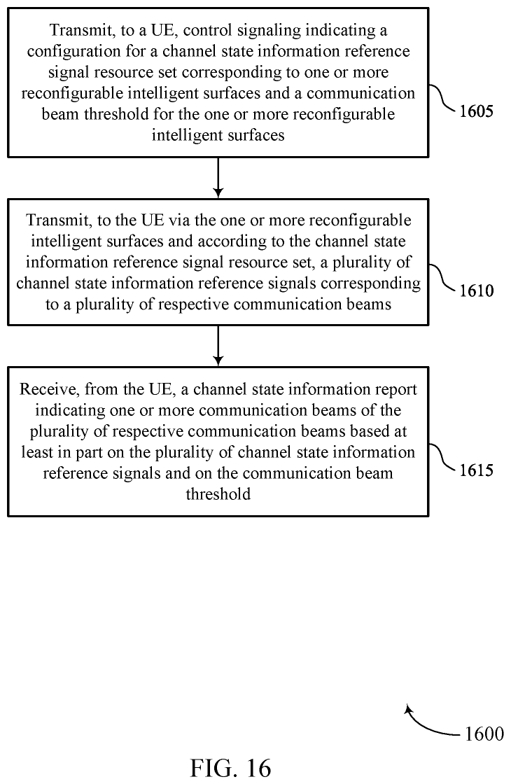

FIG. 16 shows a flowchart illustrating a method 1600 that supports CSI reporting for RISs in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, control signaling indicating a configuration for a channel state information reference signal resource set corresponding to one or more reconfigurable intelligent surfaces and a communication beam threshold for the one or more reconfigurable intelligent surfaces. The operations of 1605 may be performed in accordance with examples as disclosed herein. In some examples, aspects of the operations of 1605 may be performed by a control signaling transmitter 1225 as described with reference to FIG. 12.

At 1610, the method may include transmitting, to the UE via the one or more reconfigurable intelligent surfaces and according to the channel state information reference signal resource set, a set of multiple channel state information reference signals corresponding to a set of multiple respective communication beams. The operations of 1610 may be performed in accordance with examples as disclosed herein. In some examples, aspects of the operations of 1610 may be performed by a CSI-RS transmitter 1230 as described with reference to FIG. 12.

At 1615, the method may include receiving, from the UE, a channel state information report indicating one or more communication beams of the set of multiple respective communication beams based on the set of multiple channel state information reference signals and on the communication beam threshold. The operations of 1615 may be performed in accordance with examples as disclosed herein. In some examples, aspects of the operations of 1615 may be performed by a CSI report receiver 1235 as described with reference to FIG. 12.

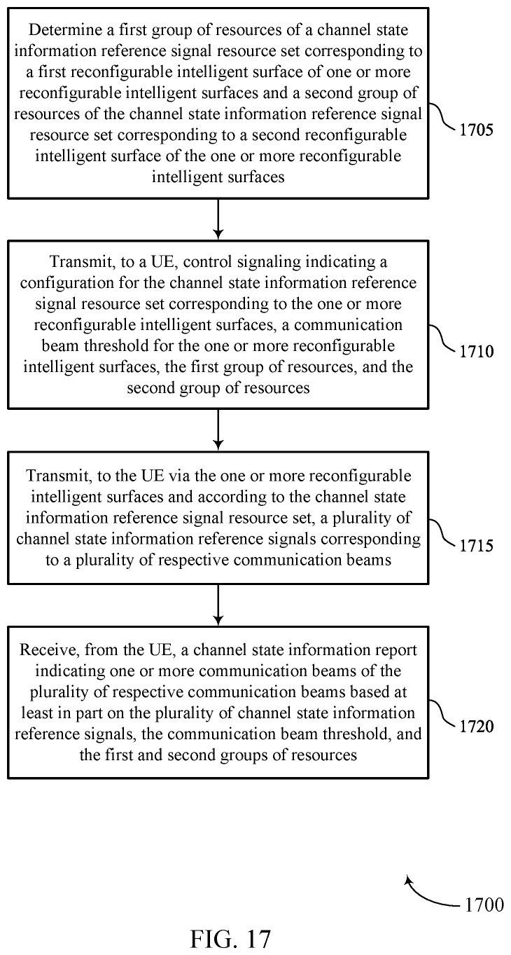

FIG. 17 shows a flowchart illustrating a method 1700 that supports CSI reporting for RISs in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include determining a first group of resources of a channel state information reference signal resource set corresponding to a first reconfigurable intelligent surface of one or more reconfigurable intelligent surfaces and a second group of resources of the channel state information reference signal resource set corresponding to a second reconfigurable intelligent surface of the one or more reconfigurable intelligent surfaces. The operations of 1705 may be performed in accordance with examples as disclosed herein. In some examples, aspects of the operations of 1705 may be performed by a resource group component 1255 as described with reference to FIG. 12.

At 1710, the method may include transmitting, to a UE, control signaling indicating a configuration for the channel state information reference signal resource set corresponding to the one or more reconfigurable intelligent surfaces, a communication beam threshold for the one or more reconfigurable intelligent surfaces, the first group of resources, and the second group of resources. The operations of 1710 may be performed in accordance with examples as disclosed herein. In some examples, aspects of the operations of 1710 may be performed by a control signaling transmitter 1225 as described with reference to FIG. 12.

At 1715, the method may include transmitting, to the UE via the one or more reconfigurable intelligent surfaces and according to the channel state information reference signal resource set, a set of multiple channel state information reference signals corresponding to a set of multiple respective communication beams. The operations of 1715 may be performed in accordance with examples as disclosed herein. In some examples, aspects of the operations of 1715 may be performed by a CSI-RS transmitter 1230 as described with reference to FIG. 12.

At 1720, the method may include receiving, from the UE, a channel state information report indicating one or more communication beams of the set of multiple respective communication beams based on the set of multiple channel state information reference signals, the communication beam threshold, and the first and second groups of resources. The operations of 1720 may be performed in accordance with examples as disclosed herein. In some examples, aspects of the operations of 1720 may be performed by a CSI report receiver 1235 as described with reference to FIG. 12.

The following provides an overview of aspects of the present disclosure:

Aspect 1: A method for wireless communications at a UE, comprising: receiving control signaling indicating a configuration for a channel state information reference signal resource set corresponding to one or more reconfigurable intelligent surfaces and a communication beam threshold for the one or more reconfigurable intelligent surfaces; receiving, according to the channel state information reference signal resource set and via the one or more reconfigurable intelligent surfaces, a plurality of channel state information reference signals corresponding to a plurality of respective communication beams; and transmitting a channel state information report indicating one or more communication beams of the plurality of respective communication beams based at least in part on the plurality of channel state information reference signals and on the communication beam threshold.

Aspect 2: The method of aspect 1, wherein the control signaling comprises a rank threshold indicator for the channel state information reference signal resource set, the method further comprising: determining a rank threshold for the one or more reconfigurable intelligent surfaces based at least in part on the rank threshold indicator, the communication beam threshold corresponding to the rank threshold.

Aspect 3: The method of any of aspects 1 through 2, wherein the control signaling comprises an indication of which resources of the channel state information reference signal resource set may be concurrently scheduled, the method further comprising: selecting the one or more communication beams based at least in part on the indication of which resources of the channel state information reference signal resource set may be concurrently scheduled, wherein the channel state information report is based at least in part on the selecting.

Aspect 4: The method of any of aspects 1 through 2, wherein the control signaling comprises an indication of which resources of the channel state information reference signal resource set may not be concurrently scheduled, the method further comprising: selecting the one or more communication beams based at least in part on the indication of which resources of the channel state information reference signal resource set may not be concurrently scheduled, wherein the channel state information report is based at least in part on the selecting.

Aspect 5: The method of any of aspects 1 through 4, further comprising: determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces; and selecting a first one or more communication beams based at least in part on the first group of resources and a first communication beam threshold and selecting a second one or more communication beams based at least in part on the second group of resources and a second communication beam threshold, wherein the channel state information report is based at least in part on the selecting the first one or more communication beams and selecting the second one or more communication beams.

Aspect 6: The method of aspect 5, wherein the control signaling further indicates the first group of resources and the second group of resources, the determining based at least in part on the control signaling.

Aspect 7: The method of aspect 5, further comprising: detecting, in a first set of channel state information reference signals of the plurality of channel state information reference signals received in the first group of resources, a first signature associated with the first reconfigurable intelligent surface and detecting, in a second set of channel state information reference signals of the plurality of channel state information reference signals received in the second group of resources, a second signature associated with the second reconfigurable intelligent surface, wherein the determining is based at least in part on detecting the first signature and detecting the second signature.

Aspect 8: The method of aspect 7, wherein the control signaling further indicates a first rank threshold corresponding to the first signature and a second rank threshold corresponding to the second signature, the first communication beam threshold corresponding to the first rank threshold and the second communication beam threshold corresponding to the second rank threshold.

Aspect 9: The method of any of aspects 1 through 4, wherein the channel state information reference signal resource set corresponds to a first reconfigurable intelligent surface; and the control signaling further configures a second channel state information reference signal resource set corresponding to a second reconfigurable intelligent surface.

Aspect 10: The method of aspect 9, wherein the communication beam threshold is for both the first reconfigurable intelligent surface and the second reconfigurable intelligent surface.

Aspect 11: The method of aspect 9, wherein the communication beam threshold is for the first reconfigurable intelligent surface; and the control signaling further configures a second communication beam threshold for the second reconfigurable intelligent surface.

Aspect 12: The method of any of aspects 9 through 11, wherein the communication beam threshold is based at least in part on a concurrent beam transmission capability of the first reconfigurable intelligent surface.

Aspect 13: The method of any of aspects 1 through 12, further comprising: selecting a precoder based at least in part on the one or more communication beams and a quantity of reconfigurable intelligent surfaces corresponding to the one or more communication beams, wherein the channel state information report further indicates the selected precoder.

Aspect 14: The method of aspect 13, wherein the precoder supports coherent precoding based at least in part on the one or more communication beams corresponding to one reconfigurable intelligent surface.

Aspect 15: The method of aspect 13, wherein the precoder supports non-coherent precoding based at least in part on the one or more communication beams corresponding to a plurality of reconfigurable intelligent surfaces.

Aspect 16: The method of any of aspects 1 through 15, further comprising: communicating data with a base station via at least one reconfigurable intelligent surface of the one or more reconfigurable intelligent surfaces using the one or more communication beams based at least in part on the channel state information report.

Aspect 17: The method of any of aspects 1 through 16, wherein the channel state information report is transmitted via at least one reconfigurable intelligent surface of the one or more reconfigurable intelligent surfaces.

Aspect 18: A method for wireless communications at a base station, comprising: transmitting, to a UE, control signaling indicating a configuration for a channel state information reference signal resource set corresponding to one or more reconfigurable intelligent surfaces and a communication beam threshold for the one or more reconfigurable intelligent surfaces; transmitting, to the UE via the one or more reconfigurable intelligent surfaces and according to the channel state information reference signal resource set, a plurality of channel state information reference signals corresponding to a plurality of respective communication beams; and receiving, from the UE, a channel state information report indicating one or more communication beams of the plurality of respective communication beams based at least in part on the plurality of channel state information reference signals and on the communication beam threshold.

Aspect 19: The method of aspect 18, further comprising: determining a rank threshold for the channel state information reference signal resource set based at least in part on an association between the plurality of channel state information reference signals and the one or more reconfigurable intelligent surfaces, wherein the control signaling comprises a rank threshold indicator indicating the rank threshold, and wherein the indicated one or more communication beams are based at least in part on the rank threshold.

Aspect 20: The method of any of aspects 18 through 19, further comprising: determining which resources of the channel state information reference signal resource set may be concurrently scheduled based at least in part on an association between the plurality of channel state information reference signals and the one or more reconfigurable intelligent surfaces, wherein the control signaling comprises an indication of which resources of the channel state information reference signal resource set may be concurrently scheduled, and wherein the indicated one or more communication beams are based at least in part on the indication.

Aspect 21: The method of any of aspects 18 through 19, further comprising: determining which resources of the channel state information reference signal resource set may not be concurrently scheduled based at least in part on an association between the plurality of channel state information reference signals and the one or more reconfigurable intelligent surfaces, wherein the control signaling comprises an indication of which resources of the channel state information reference signal resource set may not be concurrently scheduled, and wherein the indicated one or more communication beams are based at least in part on the indication.

Aspect 22: The method of any of aspects 18 through 21, further comprising: determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces, wherein the control signaling further indicates the first group of resources and the second group of resources, and wherein the indicated one or more communication beams are based at least in part on the first group of resources and the second group of resources.

Aspect 23: The method of any of aspects 18 through 21, further comprising: determining a first group of resources of the channel state information reference signal resource set corresponding to a first reconfigurable intelligent surface of the one or more reconfigurable intelligent surfaces associated with a first signature and a second group of resources of the channel state information reference signal resource set corresponding to a second reconfigurable intelligent surface of the one or more reconfigurable intelligent surfaces associated with a second signature, wherein the control signaling further indicates a first rank threshold corresponding to the first signature and a second rank threshold corresponding to the second signature, and wherein the indicated one or more communication beams are based at least in part on the first rank threshold and the second rank threshold.

Aspect 24: The method of any of aspects 18 through 21, wherein the channel state information reference signal resource set corresponds to a first reconfigurable intelligent surface; and the control signaling further configures a second channel state information reference signal resource set corresponding to a second reconfigurable intelligent surface.

Aspect 25: The method of any of aspects 18 through 24, further comprising: communicating data with the UE via at least one reconfigurable intelligent surface of the one or more reconfigurable intelligent surfaces using the indicated one or more communication beams based at least in part on the channel state information report.

Aspect 26: An apparatus for wireless communications at a UE, comprising a processor; memory coupled with the processor; and instructions stored in the memory and executable by the processor to cause the apparatus to perform a method of any of aspects 1 through 17.

Aspect 27: An apparatus for wireless communications at a UE, comprising at least one means for performing a method of any of aspects 1 through 17.

Aspect 28: A non-transitory computer-readable medium storing code for wireless communications at a UE, the code comprising instructions executable by a processor to perform a method of any of aspects 1 through 17.

Aspect 29: An apparatus for wireless communications at a base station, comprising a processor; memory coupled with the processor; and instructions stored in the memory and executable by the processor to cause the apparatus to perform a method of any of aspects 18 through 25.

Aspect 30: An apparatus for wireless communications at a base station, comprising at least one means for performing a method of any of aspects 18 through 25.

Aspect 31: A non-transitory computer-readable medium storing code for wireless communications at a base station, the code comprising instructions executable by a processor to perform a method of any of aspects 18 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving control signaling indicating a configuration for a channel state information reference signal resource set corresponding to one or more reconfigurable intelligent surfaces and a communication beam threshold for the one or more reconfigurable intelligent surfaces;
receiving, according to the channel state information reference signal resource set and via the one or more reconfigurable intelligent surfaces, a plurality of channel state information reference signals corresponding to a plurality of respective communication beams; and
transmitting a channel state information report indicating one or more communication beams of the plurality of respective communication beams based at least in part on the plurality of channel state information reference signals and on the communication beam threshold.

2. The method of claim 1, wherein the control signaling comprises a rank threshold indicator for the channel state information reference signal resource set, the method further comprising:
determining a rank threshold for the one or more reconfigurable intelligent surfaces based at least in part on the rank threshold indicator, the communication beam threshold corresponding to the rank threshold.

3. The method of claim 1, wherein the control signaling comprises an indication of which resources of the channel state information reference signal resource set may be concurrently scheduled, the method further comprising:
selecting the one or more communication beams based at least in part on the indication of which resources of the channel state information reference signal resource set may be concurrently scheduled, wherein the channel state information report is based at least in part on the selecting.

4. The method of claim 1, wherein the control signaling comprises an indication of which resources of the channel state information reference signal resource set may not be concurrently scheduled, the method further comprising:
selecting the one or more communication beams based at least in part on the indication of which resources of the channel state information reference signal resource set may not be concurrently scheduled, wherein the channel state information report is based at least in part on the selecting.

5. The method of claim 1, further comprising:
determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces; and
selecting a first one or more communication beams based at least in part on the first group of resources and a first communication beam threshold and selecting a second one or more communication beams based at least in part on the second group of resources and a second communication beam threshold, wherein the channel state information report is based at least in part on the selecting the first one or more communication beams and selecting the second one or more communication beams.

6. The method of claim 5, wherein the control signaling further indicates the first group of resources and the second group of resources, the determining based at least in part on the control signaling.

7. The method of claim 5, further comprising:
detecting, in a first set of channel state information reference signals of the plurality of channel state information reference signals received in the first group of resources, a first signature associated with the first reconfigurable intelligent surface and detecting, in a second set of channel state information reference signals of the plurality of channel state information reference signals received in the second group of resources, a second signature associated with the second reconfigurable intelligent surface, wherein the determining is based at least in part on detecting the first signature and detecting the second signature.

8. The method of claim 7, wherein the control signaling further indicates a first rank threshold corresponding to the first signature and a second rank threshold corresponding to the second signature, the first communication beam threshold corresponding to the first rank threshold and the second communication beam threshold corresponding to the second rank threshold.

9. The method of claim 1, wherein:
the channel state information reference signal resource set corresponds to a first reconfigurable intelligent surface; and
the control signaling further configures a second channel state information reference signal resource set corresponding to a second reconfigurable intelligent surface.

10. The method of claim 9, wherein the communication beam threshold is for both the first reconfigurable intelligent surface and the second reconfigurable intelligent surface.

11. The method of claim 9, wherein:
the communication beam threshold is for the first reconfigurable intelligent surface; and
the control signaling further configures a second communication beam threshold for the second reconfigurable intelligent surface.

12. The method of claim 9, wherein the communication beam threshold is based at least in part on a concurrent beam transmission capability of the first reconfigurable intelligent surface.

13. The method of claim 1, further comprising:
selecting a precoder based at least in part on the one or more communication beams and a quantity of reconfigurable intelligent surfaces corresponding to the one or more communication beams, wherein the channel state information report further indicates the selected precoder.

14. The method of claim 13, wherein the precoder supports coherent precoding based at least in part on the one or more communication beams corresponding to one reconfigurable intelligent surface.

15. The method of claim 13, wherein the precoder supports non-coherent precoding based at least in part on the one or more communication beams corresponding to a plurality of reconfigurable intelligent surfaces.

16. The method of claim 1, further comprising:
communicating data with a base station via at least one reconfigurable intelligent surface of the one or more reconfigurable intelligent surfaces using the one or more communication beams based at least in part on the channel state information report.

17. The method of claim 1, wherein the channel state information report is transmitted via at least one reconfigurable intelligent surface of the one or more reconfigurable intelligent surfaces.

18. A method for wireless communications at a base station, comprising:
transmitting, to a user equipment (UE), control signaling indicating a configuration for a channel state information reference signal resource set corresponding to one or more reconfigurable intelligent surfaces and a communication beam threshold for the one or more reconfigurable intelligent surfaces;
transmitting, to the UE via the one or more reconfigurable intelligent surfaces and according to the channel state information reference signal resource set, a plurality of channel state information reference signals corresponding to a plurality of respective communication beams; and
receiving, from the UE, a channel state information report indicating one or more communication beams of the plurality of respective communication beams based at least in part on the plurality of channel state information reference signals and on the communication beam threshold.

19. The method of claim 18, further comprising:
determining a rank threshold for the channel state information reference signal resource set based at least in part on an association between the plurality of channel state information reference signals and the one or more reconfigurable intelligent surfaces, wherein the control signaling comprises a rank threshold indicator indicating the rank threshold, and wherein the indicated one or more communication beams are based at least in part on the rank threshold.

20. The method of claim 18, further comprising:
determining which resources of the channel state information reference signal resource set may be concurrently scheduled based at least in part on an association between the plurality of channel state information reference signals and the one or more reconfigurable intelligent surfaces, wherein the control signaling comprises an indication of which resources of the channel state information reference signal resource set may be concurrently scheduled, and wherein the indicated one or more communication beams are based at least in part on the indication.

21. The method of claim 18, further comprising:
determining which resources of the channel state information reference signal resource set may not be concurrently scheduled based at least in part on an association between the plurality of channel state information reference signals and the one or more reconfigurable intelligent surfaces, wherein the control signaling comprises an indication of which resources of the channel state information reference signal resource set may not be concurrently scheduled, and wherein the indicated one or more communication beams are based at least in part on the indication.

22. The method of claim 18, further comprising:
determining a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces, wherein the control signaling further indicates the first group of resources and the second group of resources, and wherein the indicated one or more communication beams are based at least in part on the first group of resources and the second group of resources.

23. The method of claim 18, further comprising:
determining a first group of resources of the channel state information reference signal resource set corresponding to a first reconfigurable intelligent surface of the one or more reconfigurable intelligent surfaces associated with a first signature and a second group of resources of the channel state information reference signal resource set corresponding to a second reconfigurable intelligent surface of the one or more reconfigurable intelligent surfaces associated with a second signature, wherein the control signaling further indicates a first rank threshold corresponding to the first signature and a second rank threshold corresponding to the second signature, and wherein the indicated one or more communication beams are based at least in part on the first rank threshold and the second rank threshold.

24. The method of claim 18, wherein:
the channel state information reference signal resource set corresponds to a first reconfigurable intelligent surface; and
the control signaling further configures a second channel state information reference signal resource set corresponding to a second reconfigurable intelligent surface.

25. The method of claim 18, further comprising:
communicating data with the UE via at least one reconfigurable intelligent surface of the one or more reconfigurable intelligent surfaces using the indicated one or more communication beams based at least in part on the channel state information report.

26. An apparatus for wireless communications at a user equipment (UE), comprising:
a processor;
memory coupled with the processor; and
instructions stored in the memory and executable by the processor to cause the apparatus to:
receive control signaling indicating a configuration for a channel state information reference signal resource set corresponding to one or more reconfigurable intelligent surfaces and a communication beam threshold for the one or more reconfigurable intelligent surfaces;
receive, according to the channel state information reference signal resource set and via the one or more reconfigurable intelligent surfaces, a plurality of channel state information reference signals corresponding to a plurality of respective communication beams; and
transmit a channel state information report indicating one or more communication beams of the plurality of respective communication beams based at least in part on the plurality of channel state information reference signals and on the communication beam threshold.

27. The apparatus of claim 26, wherein the control signaling comprises a rank threshold indicator for the channel state information reference signal resource set, and the instructions are further executable by the processor to cause the apparatus to:
determine a rank threshold for the one or more reconfigurable intelligent surfaces based at least in part on the rank threshold indicator, the communication beam threshold corresponding to the rank threshold.

28. The apparatus of claim 26, wherein the control signaling comprises an indication of which resources of the channel state information reference signal resource set may be concurrently scheduled, and the instructions are further executable by the processor to cause the apparatus to:
select the one or more communication beams based at least in part on the indication of which resources of the channel state information reference signal resource set may be concurrently scheduled, wherein the channel state information report is based at least in part on the selecting.

29. An apparatus for wireless communications at a base station, comprising:
a processor;
memory coupled with the processor; and
instructions stored in the memory and executable by the processor to cause the apparatus to:
transmit, to a user equipment (UE), control signaling indicating a configuration for a channel state information reference signal resource set corresponding to one or more reconfigurable intelligent surfaces and a communication beam threshold for the one or more reconfigurable intelligent surfaces;
transmit, to the UE via the one or more reconfigurable intelligent surfaces and according to the channel state information reference signal resource set, a plurality of channel state information reference signals corresponding to a plurality of respective communication beams; and
receive, from the UE, a channel state information report indicating one or more communication beams of the plurality of respective communication beams based at least in part on the plurality of channel state information reference signals and on the communication beam threshold.

30. The apparatus of claim 29, wherein the instructions are further executable by the processor to cause the apparatus to:
determine a first group of resources of the channel state information reference signal resource set corresponding to a first reconfigurable intelligent surface of the one or more reconfigurable intelligent surfaces and a second group of resources of the channel state information reference signal resource set corresponding to a second reconfigurable intelligent surface of the one or more reconfigurable intelligent surfaces, wherein the control signaling further indicates the first group of resources and the second group of resources, and wherein the indicated one or more communication beams are based at least in part on the first group of resources and the second group of resources.
